(19) United States
(12) Patent Application Publication
(10) Pub. No.: US 2008/0086272 A1
(43) Pub. Date: Apr. 10, 2008

(54) Identification and use of biomarkers for the diagnosis and the prognosis of inflammatory diseases

(75) Inventor: Marianne Fillet, Nandrin (BE)

Correspondence Address: FOLEY HOAG, LLP;PATENT GROUP, WORLD TRADE CENTER WEST, 155 SEAPORT BLVD, BOSTON, MA, 02110, US

(73) Assignee: Universite de Liege Quai Van Beneden, 25, Liege (BE)

(21) Appl. No.: 11/662,133

(22) PCT Filed: Aug. 29, 2005
(86) PCT No.: PCT/EP05/54242

§ 371 Date: Mar. 7, 2007

Related U.S. Application Data
(60) Provisional application No. 60/608,670, filed on Sep. 9, 2004.

(30) Foreign Application Priority Data
Apr. 12, 2005 (EP) 05102885.0

(51) Int. Cl. G06F 19/00

(52) U.S. Cl. 702/19

(57) ABSTRACT

A method and a computer-based system for determining a classifier for a biological condition of a specific disease, an essay and a kit for assessing whether a subject is afflicted with such specific disease.

The present invention deals with a method for determining a classifier for a biological condition of a specific disease and a kit for assessing whether a subject is afflicted with such specific disease.

### BACKGROUND OF THE INVENTION

Diseases trigger biological signals indicating the presence of an abnormal condition. One goal of medical research is to find a set of signals that can be detected by non-invasive methods to achieve improved early disease detection. One avenue of research involves the development of molecular biomarkers that can be identified through tests on body fluids. Biomarkers are indicators of variation in cellular or biochemical components or processes, structures, or functions, that are measurable in biological systems or samples. The term biomarker has been used to describe measurements in the sequence of events leading from exposure to disease. At each step, for example, an organism may differ in susceptibility, thus a biomarker may also refer to an indicator of susceptibility.

In most diseases, early detection increases the chances of effectively treating the disease. However today, as in the past, disease detection generally occurs only after the onset of debilitating symptoms. Accordingly, there is an ongoing desire for clinical approaches that can be readily applied (e.g., without the need for biopsy or extensive physical examination) to detect disease, predict susceptibility to disease, predict the course of a disease, and/or its response to a given treatment.

Assuming that disease pathology will affect the physiology of the organism and cause changes in the expression level of various proteins, protein differential display techniques such as two-dimensional gel electrophoresis (2-DE), liquid chromatographic (LC), mass spectrometric etc., approaches have been applied in the attempt to establish biomarkers of both disease and non-disease states from readily obtained body fluids, e.g., urine, serum, saliva, etc. For example, modern mass spectrometry instrumentation can generate protein profiles from body fluids like serum, saliva or urine. The datasets generated by these proteomic mass spectrometry applications, however, are typically characterized by very high-dimensional attribute spaces having tens of thousands of attributes (e.g., mass spectral peaks) from a sample space having only a few hundred samples. The nature of such problems can severely limit the usefulness of classical statistical techniques such as linear discriminants, or even neural networks, unless one is able to significantly reduce the problem dimensionality. As a result, it is unclear how to analyze and interpret the enormous amount of data being generated, especially as it relates to specific clinical predictive, diagnostic and prognostic biomarkers.

Rheumatoid arthritis (RA) is a chronic autoimmune disease of unknown etiology characterized by inflammation of multiple joints resulting in tissue degradation and joint deformation. It is a systemic rheumatic disease that can also cause inflammation in organs such as eyes, heart, lung and kidney. To date the pathogenesis of rheumatoid arthritis is not fully understood, and treatment options are still limited to symptomatic and nonspecific immunosuppressive therapies. Rheumatoid arthritis, as well as other arthritis diseases such as osteoarthritis (OA) or psoriatic arthritis (PsA), involves many immunologic and inflammatory destructions of connective tissue. Because these autoimmune diseases share many common clinical findings, making a differential diagnosis remains often difficult.

Prognosis for rheumatoid arthritis is mainly determined based on clinical manifestations and serological markers such as rheumatoid factors (RFs) or anticitrullinated protein/peptide antibodies. The American College of Rheumatology (ACR; formerly, the American Rheumatism Association) in 1987 developed several criteria for the classification of rheumatoid arthritis [1]. According to the ACR, four of seven criteria have to be observed in a patient to diagnose rheumatoid arthritis. Although the sensitivity of this clinical approach is over 90%, several years are necessary to observe all the manifestations of the pathology, thus preventing early diagnosis.

Only a few serological tests for rheumatoid arthritis are currently available. One of these routinely used tests is based on the detection of rheumatoid factors (RFs), which are antibodies found in every immunoglobulin subclass (IgE, IgM, IgA and IgG) [2, 3] and directed to the constant region of immunoglobulins of the IgG subclass. Their presence can be determined by either agglutination assays, nephelometry or ELISA-based tests. Although these antibodies are present in 70-80% of rheumatoid arthritis adults, they are unfortunately also detected in other autoimmune or infectious diseases. Antibodies to anti-perinuclear factor (APF) and antikeratin (AKA) are also specific to rheumatoid arthritis. Detection of antibodies to these factors is not used routinely in laboratory tests, however, primarily for technical reasons including problems of interlaboratory reproducibility. At present, the antibody response to citrullinated antigens has the most value as a diagnostic and prognostic indicator for the progression of undifferentiated arthritis into rheumatoid arthritis [4]. Citrullinated antigen was shown to be reactive with rheumatoid arthritis autoantibodies in 76% of rheumatoid arthritis sera, with a specificity of 96%. Based on these results, an ELISA test based on cyclic citrillinated peptide (CCP) has been developed [5]. However, this ELISA test has not consistently improved the sensitivity of rheumatoid arthritis diagnosis Osteoarthritis (OA) is the most common articular disease worldwide that has always been classified as a noninflammatory arthritis. OA is the consequence of mechanical and biological events that destabilize tissue homeostasis in articular joints. It is characterized by a disregulation of tissue turnover in the weight-bearing articular cartilage and subchondral bone. Rheumatoid arthritis may be differentiated from OA by laboratory findings on the basis of systemic inflammation, a positive rheumatoid factor, joint fluid with polymorphonuclear cell predominance, and substantially WBC count.

Psoriatic arthritis (PsA) is a chronic disease characterized by inflammation of the skin and joints. The cause of PsA is currently unknown, but may involve a genetic factor such as the HLA-B27 gene. PsA is mainly detected on clinical grounds. Approximately 10% of patients who have psoriasis also develop an associated inflammation of their joints. The absence of rheumatoid factors in blood tests is used to distinguish PsA from rheumatoid arthritis. Another difference between these two pathologies relies on the highly destructive potential of the rheumatoid arthritis synovial membrane and in the local and systemic autoimmunity.

Even if the three related pathologies of rheumatoid arthritis, osteoarthritis and psoriatic arthritis can be distinguished on clinical grounds at an advanced stage of the disease, it remains difficult to make a correct diagnosis at an earlier stage. Commonly used biomarkers for rheumatoid arthritis such as CCP do not produce an unequivocal diagnosis. Moreover, a clear diagnosis of rheumatoid arthritis at an early stage is very important for determining the appropriate timing and amount of therapy with immunosuppressive drugs. Thus, there is a clear need in the art to take current serum screening for rheumatoid arthritis, including tests based on CCP, one step further by identifying multiple biomarkers that are associated with rheumatoid arthritis.

Crohn Disease (CD) and Ulcerative Colitis (UC) both generally known as Inflammatory Bowel Diseases (IBD) are chronic autoimmune inflammatory pathologies affecting the gastro intestinal tract. Their ethiopathogenesis has not been fully elucidated and involves a complex interplay among genetic, environmental, pathogenic and immune factors. The still growing knowledge in the ethiology of these disorders gave rise to new promising treatments. Nevertheless, the success of those drugs are cases dependent: CD or UC. Therefore, accurate and fast diagnosis is a real important need in circumventing these pathologies.

Machine learning offers various methods to extract information in various forms from datasets. In a supervised learning problem, the datasets are composed of samples described by input variables and specific output information, and the objective is to derive from the dataset a synthetic model which predicts the output information of a sample as a function of its input variables. Herein the term attribute denotes a particular input variable used in a supervised learning problem, the term classifier is used to denote a synthetic model predicting output information in the form of a discrete class, and the term learning set is used to denote a dataset used by a supervised learning algorithm. Practically, a classifier is a protocol to exploit the biomarkers information to determine the biological condition of a specific disease. All statistical parameters used herein are welknown by the man skilled in the art. For example different algorithms or algorithm family (CART, pruning, boosting, Adaboost, Hull, learning and induction and the like) are defined in the incorporated references.

### SUMMARY OF THE INVENTION

In various aspects, the present invention provides a method based on machine learning techniques for determining a biomarker or a combination of biomarkers for a biological condition of a specific disease.

By biological condition of a specific disease, one means a presence or absence of a specific disease, a positive or negative response to a specific treatment for a specific disease, a susceptibility or not to a specific disease, and any other health statement related to a specific disease.

The present invention provides a method for determining a classifier for this biological condition of a specific disease, exploiting one or more biomarkers. Such biomarkers can facilitate, for example, diagnosis, the ability to discriminate among a certain class of diseases, be indicative of treatment response, and facilitate constructing decision rules exploiting the biomarkers' intensities to help physicians in the context of diagnosis and prognosis (medical prediction of a susceptibility to a disease without clinical manifestations and prediction of the response to a given treatment). The methods can use experimental datasets obtained from proteomic mass spectrometry to determine one or more biomarkers for a biological condition of a specific disease and a classifier for this biological condition exploiting one or more biomarkers.

In various embodiments, a method of determining a biomarker or a combination of biomarkers for a biological condition of a specific disease comprises providing a plurality of mass spectra and determining input attributes from one or more of the plurality of mass spectra to generate a first learning set. Several classifiers are then determined for the learning set using four or more ensemble of decision trees methods, a classifier being determined for each ensemble of decision trees method. The method then evaluates one or more of the sensitivity, specificity, and error rate for each classifier and selects one of the classifiers as a candidate classifier based on at least one or more of sensitivity, specificity, and error rate. The attributes are ranked according to their relative contribution to the information provided by the selected classifier (e.g., according to importance in the “best” ensemble of decision trees model identified by leave-on-out cross-validation). The steps of determining classifiers, evaluating them and selecting them are repeated using only the top ranked attributes while progressively increasing their number. The accuracy estimates (e.g., by cross-validation) of the resulting sequence of classifiers provides a learning curve which typically first increases then reaches a maximum and decreases. The set of attributes corresponding to the maximum accuracy are then retained as the candidate set from which a set of one or more biomakers is determined and the classifier corresponding to the maximum accuracy is retained as the final classifier from which prediction about the biological condition can be done.

In various aspects, the present invention provides a method of assessing whether a subject is afflicted with a biological condition of a specific disease as for example suffering from rheumatoid arthritis or having a risk for developing rheumatoid arthritis by detecting the presence of a set of biomarkers in a subject sample. Particularly for rheumatoid arthritis, the method is detecting the presence of a set of biomarkers comprising one or more polypeptides having a molecular mass listed in Table 3, Table 4, and Table 5; and comparing the presence of the biomarkers in the subject sample to corresponding biomarkers in several groups of control samples, wherein a significant difference between the protein mass spectra of the two groups is an indication that the subject is afflicted with rheumatoid arthritis or at risk for developing rheumatoid arthritis.

In various aspects, the present invention provides a method of assessing whether a subject is afflicted with a biological condition of a specific disease as for example suffering from rheumatoid arthritis or having a risk for developing rheumatoid arthritis by (a) obtaining a proteomic mass spectrum of a subject sample (b) computing the cumulative intensity values in the mass spectrum over specific molecular mass ranges (for example, for rheumatoid arthritis, the molecular mass ranges from Table 3, Table 4, and Table 5); and (c) by using a classifier inferred by machine learning techniques and exploiting these intensities to give an indication about whether or not the subject is afflicted with a biological condition of a specific disease.

The present invention also provides a biomarker or a combination of biomarkers identified by the above method. It provides an assay and a kit for assessing whether a subject is in a biological condition of a specific disease comprising a reagent for assessing the presence in a subject sample of a set the biomarkers. It also provides a method of diagnosis of a specific disease employing a biomarker or a biomarker combination identified by the above method.

A mass spectrometer typically provides signals in a range of mass-to-charge ratios (m/z) between about 0 to about 20,000 Daltons (Da), with a typical resolution in the range between about 0.5 to about 5 Da. This leads typically to an attribute vector of 10,000 to 20,000 numerical values for each mass spectrum analysis. For example, in practice a SELDI-TOF MS for a given patient can be obtained from a sample preprocessed on two or three different SELDI surfaces and in two or four different replicas; thus, potentially, leading to more than 100,000 numerical input attributes per patient. While the number of input attributes can be very high, in these medical applications the number of patients (in other words the number of samples for the method) is, in comparison, small (e.g., only several tens or hundreds of patients for each class).

In various embodiments, the methods of determining biomarkers and classifiers are scalable both with respect to the number of input attributes and the number of samples. For example, in various embodiments, the methods can be used with datasets where the number of attributes is (much) larger than the number of samples and/or where the large majority of input variables are irrelevant. In various embodiments, the computational complexity of the methods of the present invention is substantially linear in the number of input variables.

In another aspect, the present invention provides computer-based system for determining biomarkers and a classifier for a biological condition. In various embodiments, a computer based systems comprises: a processor capable of accessing a database of mass spectrometric signals from individual members of a test population, a first subpopulation of said members being identified as having a specified biological condition and a second subpopulation of said members being identified as not having the specified biological condition; and a computer-readable medium having embedded thereon computer-readable instructions that include steps for performing one or more of the methods of the present invention.

In another aspect, articles of manufacture are provided where the functionality of one or more methods of the invention are embedded as computer-readable instructions on a computer-readable medium, such as, but not limited to, a floppy disk, a hard disk, an optical disk, a magnetic tape, a PROM, an EPROM, CD-ROM, DVD-ROM, or resident in computer or processor memory. The functionality of a method can be embedded on the computer-readable medium in any number of computer readable instructions, or languages such as, for example; FORTRAN, PASCAL, C, Con, BASIC and, assembly language. Further, the computer-readable instructions can, for example, be written in a, script, macro, or functionally embedded in commercially available software, (e.g. EXCEL or VISUAL BASIC).

### BRIEF DESCRIPTION OF THE DRAWINGS

FIG. 1 are spectra depicting an optimization step on CM10 arrays using a quality control serum sample that was diluted 35-fold and which involved testing several washing buffers at different pH values (from pH 3 to pH 9).

FIG. 2 are spectra depicting an optimization step on H4 arrays using a quality control serum sample that was diluted 5-fold and which involved testing several washing buffers with different percentages (from 10% to 60%) of acetonitrile (hereafter called ACN).

FIGS. 3A-F presents the reproducibility demonstrated by the quality control serum sample on CM10 arrays before the analysis of the 34 RA serum samples (spectra A to C) and 6 months later (spectra D to F).

FIGS. 4A-B depict the identification of potential biomarkers of m/z=10832, 11632, and 11706 on an CM10 array, where the biomarkers discriminate between rheumatoid arthritis and controls. (A) Mean value of all the spectra. The black and grey lines represent the control and RA spectra, respectively. (B) A gel view of all the spectra, where control spectra are below the line and RA spectra are above the line.

FIG. 5 depicts a flow diagram illustrating various embodiments of methods for determining biomarkers for a biological condition.

### DETAILED DESCRIPTION OF THE INVENTION

The Invention will now be detailed for a specific disease such as rheumatoid-arthritis but is also applicable to any other inflammatory disease such as Crohn's disease, ulcerative colitis, psoriatic arthritis, osteoartritis, asthma, chronical bronchopneumopathy and any other non-inflammatory disease.

Rheumatoid arthritis (RA) is a systemic disease characterized by a chronic inflammation of synovial membranes of multiple joints in the body, causing pain, functional disability and ultimately joint destruction. The biologic hallmark of rheumatoid arthritis has been the rheumatoid factor, an anti-IgG autoantibody. This antibody, however, is not specific for rheumatoid arthritis and is found in only 70-80% of rheumatoid arthritis patients. A more recently developed anti-CCP antibody test shows a higher specificity for rheumatoid arthritis, but its sensitivity remains between 68 and 80%. The identification of new rheumatoid arthritis protein biomarkers having higher specificity and sensitivity is therefore of high interest.

The present invention is based, at least in part, on the proteomic analysis of serum samples from patients classified into the three groups of rheumatoid arthritis, inflammatory and non-inflammatory diseases. A total number of 103 serum samples from patients were investigated, of which 34 patients were diagnosed with rheumatoid arthritis on the basis of the ACR criteria. The inflammatory control group consisted of 20 psoriatic arthritis (PsA), 9 asthma and 10 Crohn patients, whereas the non-inflammatory group consisted of 14 osteoarthritis (OA) patients and 16 unaffected healthy controls. Surface Enhanced Laser Desorption/Ionisation-Time of Flight-Mass Spectrometry (SELDI-TOF-MS) was used to obtain protein profiles for each of the three patient sets, and these protein profiles were compared and statistically analyzed to identify new biomarkers specific to rheumatoid arthritis. Several biomarkers were identified as specific biomarkers to rheumatoid arthritis using two different protein chip arrays. The sensitivity of this method was calculated and found to be higher than the currently used anti-CCP antibodies test for rheumatoid arthritis. SELDI-TOF used together with the statistical methods described herein is therefore a rapid and sensitive method for identifying specific biomarkers of rheumatoid arthritis.

The SELDI approach employs a variety of selective chips composed of different chromatographic chemically active surfaces (e.g., anionic, cationic, hydrophobic, hydrophilic or metal ion) on which a biological sample (such as serum) is applied. Proteins are captured on a ProteinChip array by, for example, Lewis acid-basis interaction, charge, hydrophobicity or chromatographic affinity. Hence, each surface preferentially binds a particular class of proteins based on its physiochemical properties and gives rise to a specific pattern. After several washes to eliminate unspecific interactions, proteins are co-crystallized with an excess of energy absorbing matrix molecules. A laser then desorbs and ionizes the proteins. Ions are detected and displayed, with the corresponding mass-to-charge ratio (m/z), on a typical spectrum as a peak whose amplitude or area is dependent on its abundance.

Accordingly, the invention provides, in various aspects, a method of assessing whether a subject is afflicted with rheumatoid arthritis or at risk for developing rheumatoid arthritis, the method comprising the steps of: a) detecting the presence of a set of biomarkers in a subject sample, wherein the set of biomarkers comprises one or more polypeptides having a molecular mass listed in Table 3, Table 4, or Table 5; b) comparing the presence of the biomarkers in the subject sample to corresponding biomarkers in control groups, wherein a significant difference between the expression of the biomarkers in the subject sample and a group of control samples is an indication that the subject is afflicted with rheumatoid arthritis or at risk for developing rheumatoid arthritis.

In one embodiment of these aspects, said step of detecting comprises obtaining a mass spectrum for the sample and inspecting said mass spectrum for peaks indicative of said one or more biomarkers. In one embodiment, the mass spectrum is obtained using a surface-enhanced laser desorbtion ionization-time-of-flight (SELDI-TOF) mass spectrometer. In various embodiments, the SELDI-TOF mass spectrometer comprises a protein chip having a weak cation-exchange surface or a hydrophobic surface.

In other embodiments of these aspects, said assessing differentiates rheumatoid arthritis from psoriatic arthritis. In one embodiment, said assessing is an adjunct to a primary diagnostic test for rheumatoid arthritis, e.g., a test for the presence of anti-cyclic citrillinated peptide (CCP) antibodies. In a preferred embodiment of these aspects, the subject sample is serum from the subject.

In one embodiment of these aspects, the invention provides a kit for assessing whether a subject is afflicted with rheumatoid arthritis, the kit comprising a reagent for assessing the presence of a set of biomarkers in a subject sample, wherein the set of biomarkers comprises one or more polypeptides having the molecular masses listed in Table 3, Table 4, or Table 5.

In one embodiment, the invention provides a method of assessing whether a subject is afflicted with rheumatoid arthritis or at risk for developing rheumatoid arthritis, the method comprising detecting the presence of each biomarker of a biomarker panel in a subject sample and comparing the presence of the biomarker in the subject sample to the corresponding biomarker of control groups, wherein the biomarkers of the biomarker panel are selected from the group consisting of polypeptides having the molecular masses listed in Table 3, Table 4, or Table 5, and wherein an altered expression of the biomarkers in the sample indicates that the subject is afflicted with rheumatoid arthritis or at risk for developing rheumatoid arthritis.

In yet another embodiment of these aspects, the invention provides a method for monitoring the progression of rheumatoid arthritis in a subject, the method comprising: a) detecting in a subject sample at a first point in time, the presence of a set of biomarkers, wherein the set of biomarkers comprises one or more polypeptides having the molecular masses listed in Table 3, Table 4, or Table 5; b) repeating step a) at a subsequent point in time; and c) comparing the presence of the set of biomarkers detected in steps a) and b), and therefrom monitoring the progression of rheumatoid arthritis in the subject.

In another aspect, the invention features a method for identifying a biomarker or a biomarkers combination for rheumatoid arthritis, comprising a method of analysis according to various embodiments of the invention.

The invention further provides, in a related aspect, a biomarker or a biomarkers combination identified by said method. The invention also provides, in another related aspect, a method of diagnosis of rheumatoid arthritis employing a biomarker or a biomarker combination identified by said method. The invention still further provides, in yet another related aspect, an assay which employs a biomarker identified by said method.

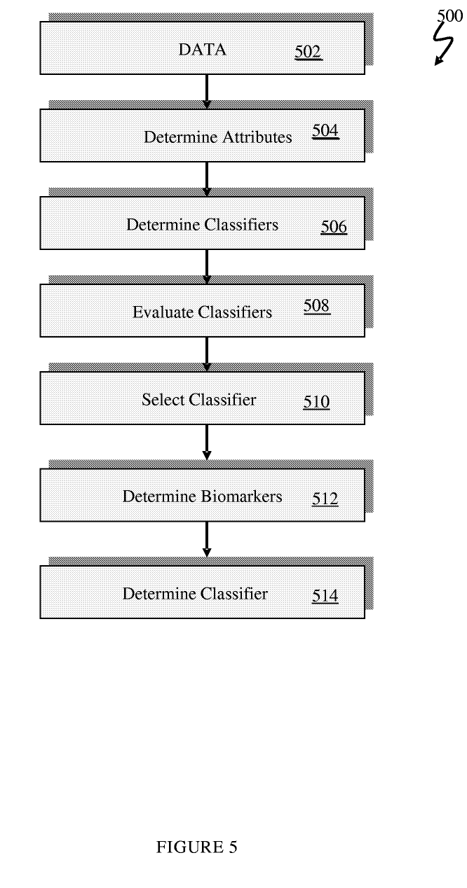

In various aspects, the present invention provides methods for determining biomarkers and a classifier that exploits the intensities of the biomarkers for a biological condition, such as, for example, a specific disease, a disease state, a treatment response, and/or susceptibility to a disease. The steps of various embodiments of a method for determining biomarkers and classifiers in accordance with the present invention are depicted schematically in FIG. 5. Each of these steps will be described generally below, followed by a more detailed discussion. In various embodiments, the methods 500 begin with the provision of a plurality (two or more) of mass spectra 502 of biological samples taken from individual members of a test population, where at least a first subpopulation of the test population is identified as having a specified biological condition and at least a second subpopulation of the test population is identified as not having the specified biological condition. The mass spectra are preprocessed to determine the input attributes to define the learning set 504 to be used by the ensembles of decision trees methods to determine an initial classifier for the biological condition. Preferably, the input attributes are determined using a discretization approach. A set of classifiers is then determined for the learning sample using several ensemble of decision trees methods 506. Preferably, at least four different decision tree based ensemble methods are used, a classifier being determined for each ensemble method. The classifiers for each decision tree based ensemble model are then evaluated 508 based on one or more of the sensitivity, specificity and error rate to evaluate the corresponding ensemble of decision trees model. One of the classifiers is then selected as a candidate classifier 510 based on one or more of the sensitivity, specificity, and error rate of the corresponding ensemble of decision trees model. In various embodiments, this candidate ensemble of decision trees is used to determine a set of one or more biomarkers for the biological condition 512 which are used as input attributes to determine a new classifier 514.

Mass Spectra and Biological Samples

Mass spectra can be obtained, for example, from biological samples collected from different patients classified in two or more different classes (e.g., disease vs. control, disease A vs. disease B, successful vs. unsuccessful treatment, prior to onset of disease vs. after onset of disease, having disease vs. not having disease), and which can be processed one or several times (replicas) by a mass spectrometer after, e.g., sample fractionation under different physical conditions (e.g., on different chromatographic chemically active surfaces). Examples of biological samples from which mass spectra can be obtained include, but are not limited to, cell lysates, cellular secretion products, body fluids (such as, e.g., serum, plasma, urine, lymph, cerebrospinal fluid, amniotic fluid, synovial fluid, sebum, and saliva), tissue homogenates, and whole organism homogenates. For example, a body fluid can contain several thousands of proteins or peptides that regulate a vast number of physiological functions that may be related to the pathology. Identification of a biomarker pattern in these body fluids, for example, can, in various embodiments, provide information which facilitates making a valid clinical diagnosis before the onset of symptoms.

Any suitable mass spectrometry technique can be used to obtain a mass spectrum of the biological sample under investigation. Suitable mass spectrometry techniques include any suitable sample ionization technique coupled with any suitable mass spectrometer. Suitable ionization techniques include, but are not limited to, surface-enhanced laser desorption/ionization (SELDI), matrix assisted laser desorption ionization (MALDI), and electrospray ionization. Suitable mass spectrometers include, but are not limited to, time-of-flight (TOF) instruments, and radio-frequency instruments such as quadrupoles and other multi-pole instruments. In a preferred embodiment the mass spectrometry technique is surface-enhanced laser desorption/ionization time-of-flight (SELDI-TOF).

A biological sample can be subject to a fractionation technique prior to obtaining a mass spectrum of one or more of the resultant fractions. Suitable fractionation techniques include, but are not limited to, one-dimensional gel electrophoresis, two-dimensional gel electrophoresis, capillary electrophoresis, and liquid chromatography (LC).

Mass spectra typically are provided in an electronic format that includes the raw data. More often than not, it is desirable to “process” the raw data that constitutes the mass spectrum. Preferably, the mass spectra are processed prior to use to perform, for example, one or more of the following: adjust the calibration of the mass scale of a mass spectrum, align the mass scale, remove noise, remove spurious signals, remove random errors or systemic errors arising from the mass spectrometry technique used to obtain the mass spectrum, correct for isotopic variations, identify and/or remove baseline, normalize the signal intensities, and convolute with an instrument response function.

Determining Input Attributes

Mass spectrometry on protein containing samples usually provides rather noisy signals, both in terms of intensities and mass-to-charge ratios. When these mass spectra are represented as a set of input variables (attributes) corresponding to measurement intensities in fixed m/z intervals (e.g., using a peak detection approach), the intensity measurement error translates into additive noise, while the m/z measurement errors may lead to shifting the information from one attribute to another. Therefore, while small intensity measurement errors will correspond to small distances in the attribute space, small m/z measurement errors on high intensity peaks will lead to large distances in the attribute space. This kind of error can therefore be detrimental in machine learning applications.

Accordingly, in various preferred embodiments, the methods of the present invention do not select input variables (attributes) in a fixed m/z intervals. In preferred embodiments, the methods select input variables (attributes) using a m/z discretization method with a roughness parameter r that can be adapted. For example, in various embodiments, given the value of a roughness parameter r in [0, 1]:
(1) Let m be the smallest m/z ratio present in a spectrum;
(2) Create a new attribute which value is equal to the cumulative intensity values in the m/z interval [m;m+r.m];
(3) Set m=m+r.m;
(4) Unless m is larger than the largest m/z value in the original data, return to step 2.
   The roughness parameter r determines the relative width of each interval and also the number of attributes resulting from this procedure. The larger the value of r is, the smaller the number of attributes and the less noisy they are. On the other hand, if the value of r is too large, there is a risk of loosing relevant information. Hence, to adapt the value of r to problem specifics and data acquisition conditions, in preferred embodiments, the step of selecting input attributes comprises trying several values of r and using a cross-validation approach to select the best value.
   Determining Classifiers

In the methods of the present invention, classifiers are determined from a learning set using ensembles of decision trees methods.

Single Decision Tree Induction

A decision tree can be described as a classification model represented by a tree where each interior node is labeled with a test based on a single attribute and each terminal node is labeled with the name of a class. To retrieve the classification of a sample described by its input attribute values, it can be propagated into the tree by answering to the tests until a leaf node is reached and sample classified according to the class-label attached to this leaf. By construction, a decision tree is thus interpretable as one can follow the tests that lead to a particular classification.

A decision tree can be built in a recursive way, starting with a single terminal node and trying at each step to add the “best” possible test at one of the terminal nodes of the partially developed tree. Candidate tests can be ranked according to a score measure that evaluates their capability to discriminate among the different classes in the local sample attached to the node under consideration. Candidate tests for numerical attributes can be of the form [A<aₜₕ] where A denotes the attribute value and aₜₕ the split threshold. The search for the “best” test can be conducted in two steps: first, the “best” threshold can be determined for each candidate attribute and then, the “best” attribute along with its “optimal” threshold can be selected to split the node. The decision to stop the development of a tree branch can be taken according to a so-called stop splitting criterion. We can split until all samples at a terminal node either belong to the same class or share the same attribute values. This tree growing phase can be combined with a postpruning phase to remove parts of the tree that, for example, overfit to the random features of dataset. Tree induction algorithms differ, for example, in the choices of a score measure, a stop splitting criterion, and a pruning algorithm.

In various embodiments of the methods, a CART tree growing algorithm is used with cost-complexity pruning by ten fold cross-validation together with an information theoretic score measure. Examples of which can be found, respectively, in L. Breiman, J. Friedman, R. Olsen, and C. Stone, Classification and Regression Trees. Wadsworth International (California), 1984, and L. Wehenkel, Automatic learning techniques in power systems. Boston: Kluwer Academic, 1998, entire contents of both of which are hereby incorporated herein by reference. The computational complexity of this CART tree growing method is substantially linear in the number of candidate input attributes and the tree complexity (number of test nodes) and the number of attributes selected at the tree nodes are bounded by the number of learning samples.

Ensembles of Decision Tree Methods

Ensemble decision trees methods can be used to build several trees and define a classifier by aggregating the classes predicted by these trees. There exist many tree-based ensemble methods, depending on the way the individual trees are built and how their predictions are aggregated. Empirical studies have been carried out comparing these methods and, generally, no method has been found superior to all others in all situations. However, for a given application it is generally not possible in advance to predict which one of these methods would lead to the “best” compromise between sensitivity and specificity.

In various embodiments of the methods of the present invention, the four following decision tree based ensemble methods are used to determine sets of classifiers from a learning sample:
(1) Bagging In bagging, each tree of the ensemble can be built by the CART algorithm (without pruning) but from a bootstrap sample drawn from the original learning set (e.g., a sample of the same size as the original sample drawn with replacement from this sample). The predictions of these trees can be aggregated by a simple majority vote approach. Examples of bagging ensemble of decision trees approaches are described in L. Breiman, “Bagging predictors,” Machine Learning, vol. 24, no. 2, pp. 123-140, 1996, the entire contents of which are hereby incorporated herein by reference.
(2) Random Forests This method can be described as a modification of bagging. In this method, when splitting a node, k attributes are selected at random among all candidate input attributes, an optimal split threshold is determined for each one of these and the “best” split is selected among these latter. In Example 2, the value of k has been fixed to its default value which is equal to the square root of the number of attributes. Examples of random forest ensemble of decision trees approaches are described in L. Breiman, “Random forests,” Machine learning, vol. 45, pp. 5-32, 2001, the entire contents of which are hereby incorporated herein by reference.
(3) Extra-trees. Unlike bagging and random forests, this method generates each tree from the whole learning set. During tree growing, the “best” split is selected among k totally random splits, obtained by choosing k attributes and split thresholds at random. In Example 2, the value of k for this method has also been fixed to the square root of the number of attributes. Examples of extra-trees ensemble of decision trees approaches are described in P. Geurts, D. Ernst, L. Wehenkel, “Extremely randomized trees,” University of Li'ege, Department of Electrical Engineering and Computer Science, Tech. Rep., Avril 2004, the entire contents of which are hereby incorporated herein by reference.
(4) Boosting. While in the three preceeding methods the different trees are built independently of each other, boosted trees can be built in a sequential way. Each tree of the sequence can be grown with the classical induction algorithm but by increasing the weights of the learning samples that are misclassified by the previous trees of the sequence. When making a prediction, the votes of the different trees are weighted according to their accuracy on the learning set. In Example 2, the original Adaboost algorithm is used examples of which are described in Y. Freund and R. Schapire, “A decision-theoretic generalization of online learning and an application to boosting,” in Proceedings of the Second European Conference on Computational Learning Theory, 1995, pp. 23-27, the entire contents of which are hereby incorporated herein by reference.
   Evaluating and Selecting Classifiers

In order to select a classifier among a set of classifiers, the methods of the present invention, in various embodiments, compute an estimate of its accuracy. Various preferred embodiments of the methods of the present invention use leave-one-out cross-validation to estimate the accuracy of an ensemble of decision trees model. Leave-one-out cross-validation can be described as removing each sample in turn from the learning set, building a model from the remaining N−1 samples, and then classifying this sample with this model, to obtain a prediction for each learning sample and the accuracy of a model can be estimated by the accuracy of this latter prediction. Assuming binary classification problems, the accuracy of a model can be measured by three values:
(i) Sensitivity: the percentage of samples from the target class that are correctly classified by the model (true positives).
(ii) Specificity: the percentage of samples from the other class that are correctly classified by the model (true negatives).
(iii) Error rate: the percentage of samples (whatever their classes) that are misclassified by the model.

In practice, the selection of a model among several models according to these three measures depends, for example, on the importance or cost of misclassification in each class. In Example 2, the classifiers are selected based on the global error rate.

In various embodiments, to provide a set of attributes which determine the classification, it is furthermore possible to compute from a tree a finer measure to rank these attributes according to their relative relevance or contribution to the classification.

Attribute Ranking

Several measures have been proposed in the literature for ranking attributes with decision trees. (See, e.g., L. Breiman, J. Friedman, R. Olsen, and C. Stone, Classification and Regression Trees. Wadsworth International (California), 1984; L. Breiman, “Random forests,” Machine learning, vol. 45, pp. 5-32, 2001; and T. Hastie, R. Tibshirani, and J. Friedman, The elements of statistical learning: data mining, inference and prediction. Springer, 2001; the entire contents of all of which are hereby incorporated herein by reference.)

In preferred embodiments, attributes are ranked using an information measure from L. Wehenkel, Automatic learning techniques in power systems. Boston: Kluwer Academic, 1998, the entire contents of which are hereby incorporated herein by reference. At each interior node, one computes the total reduction of the classification entropy due to the split of the node, as defined by the following expression:
I(node)=#SH_{C}(S)−#SₜH_{C}(Sₜ)−#S_{f}H_{C}(S_{f}), (1)
where S and #S denote respectively the subset of samples from the learning set that reach this node and its size, Sₜ (S_{f}) denotes the subset of them for which the test is true (false) and H_{C}(·) computes the Shannon entropy of the class frequencies in a subset of samples. According to this measure, a split is more important when it concerns many cases (#S is large) and when it discriminates well between classes. The relative importance of an attribute for the classification is then defined by the sum of the I values over all nodes where this attribute is used to split. This measure of attribute importance can be used for a single tree or for an ensemble of trees by averaging over the nodes of a single tree or of the ensemble. Those attributes that are not selected at all obtain a score of zero, and those attributes that are selected close to the root nodes of the trees typically (but not necessarily) obtain the higher scores. To interpret the values more easily, it is preferable to normalize them so that they then represent the relative contribution of the attributes to the information provided by a tree (or an ensemble of trees).
Class Merging

In a number of practical problems, biological samples are obtained from patients that can be categorized into more than two classes. For example, when trying to diagnose a particular disease, the control group is usually composed of healthy patients and patients suffering from some diseases different or close to the targeted disease. However, an investigator may be primarily interested in discriminating some group of patients from all other classes. In this case, e.g., one approach, in various embodiments of determining a set of biomarkers and a classifier, use the complete class information when building the trees and merge a posteriori (e.g., after selecting a candidate classifier) the labels of terminal nodes according to the desired binary classification scheme. But, it is also possible to merge the classes which don't need to be discriminated before determining the input attributes.

Aggregation of Measurements

Often, several measurements or spectra are available for a given patient. These spectra may correspond to several replicas of the same experiment or to different experimental conditions (e.g. different chemical properties of the chip surfaces). Depending on the sought objectives, one can suggest several methods to aggregate the information contained in these sets of measurements. For example, in the case of multiple chip surfaces, and if the objective is to maximize predictive accuracy, in various embodiments, the methods merge the corresponding attributes before determining sets of classifiers using the ensembles of decision trees. On the other hand, if the objective is to select one of the different surfaces for further analysis, one would treat them separately.

In various embodiments, one approach to take advantage of several replicas per patient is to aggregate the individual classification of these replicas with a voting scheme.

Determining Biomarkers

In various embodiments, an iterative approach (step 512 of FIG. 5) is used to determine a set of biomarkers. For example, in various situations, although attribute importances give a ranking of attributes, there are usually many of them that receive a close to zero importance, and it is not necessarily straightforward to define a priori a threshold below which attributes could be dropped to determine a set of biomarkers. Therefore, in various preferred embodiments, the methods of the present invention use one or more iterations to determine a candidate set of attributes from which a set of biomarkers is determined.

For example, in various embodiments, a method of determining a biomarker or a combination of biomarkers for a biological condition comprises providing a plurality of mass spectra and determining input attributes from one or more of the plurality of mass spectra to generate a first learning set. Several classifiers are then determined for the learning set using four or more ensemble of decision trees methods, a classifier being determined for each ensemble of decision trees method. The method then evaluates one or more of the sensitivity, specificity, and error rate for each classifier and selects one of the classifiers as a candidate classifier based on at least one or more of sensitivity, specificity, and error rate. The attributes are ranked according to their relative contribution to the information provided by the selected classifier (e.g., according to importance in the “best” model identified by leave-on-out cross-validation).

The steps of determining classifiers, evaluating them and selecting them are repeated using only the top ranked attributes while progressively increasing their number. The accuracy estimates (e.g., by cross-validation) of the resulting sequence of classifiers provides a learning curve which typically first increases then reaches a maximum and decreases. The set of attributes corresponding to the maximum accuracy are then retained as the candidate set from which a set of one or more biomakers is determined. The classifier corresponding to the maximum accuracy is retained as the final classifier from which prediction about the biological condition can be done.

In another aspect, the present invention provides computer-based system for determining a biomarker for a biological condition. In various embodiments, a computer based systems comprises: a processor capable of accessing a database of mass spectrometric signals from individual members of a test population, a first subpopulation of said members being identified as having a specified biological condition and a second subpopulation of said members being identified as not having the specified biological condition; and a computer-readable medium having embedded thereon computer-readable instructions that include steps for performing one or more of the methods of the present invention. In various embodiments, the computer-readable instructions include steps for: determining input attributes from one or more mass spectra to generate a first learning set; determining for the learning set four or more classifiers, each classifier being determined using an ensemble of decision trees method; evaluating for each of said classifiers one or more of sensitivity, specificity, and error rate; selecting one of said classifier as a candidate classifier based on at least one or more of sensitivity, specificity, and error rate; and determining a set of one or more biomarkers from the candidate classifier.

In various embodiments, the computer-based system comprises an output device. In one embodiment, the output device produces a human readable display, for example, such as that produced by a printer or computer screen. However, it is not crucial the present invention whether the output device produces either a human readable and/or machine readable only output. For example, the output device may produce machine readable only data.

In various embodiments of the computer-based systems of the present invention, data, the computer-readable instructions may be implemented as software on a general purpose computer. In addition, such a program may set aside portions of a computer's random access memory to provide the program logic that affect comparisons between and the operations with and on the data.

In another aspect, the functionality of one or more of the methods described above may be implemented as computer-readable instructions on a general purpose computer. The computer may be separate from, detachable from, or integrated into a one of a number of high-level languages, such as, for example, FORTRAN, PASCAL, C, Con, or BASIC. Further, the computer-readable instructions may be written in a script, macro, or functionality embedded in commercially available software, such as EXCEL or VISUAL BASIC. Additionally, the computer-readable instructions could be implemented in an assembly language directed to a microprocessor resident on a computer. For example, the computer-readable instructions could be implemented in Intel 80×86 assembly language if it were configured to run on an IBM PC or PC clone.

In one embodiment, the computer-readable instructions can be embedded on an article of manufacture including, but not limited to, a computer-readable program medium such as, for example, a floppy disk, a hard disk, an optical disk, a magnetic tape, a PROM, an EPROM, or CD-ROM.

### EXAMPLES

Aspects, embodiments, and features of the present inventions may be further understood from the following examples, which should not be construed as limiting the scope of the present teachings in any way. The contents of all references, figures, Sequence Listing, patents and published patent applications cited throughout this application are hereby incorporated by reference.

### Example 1

In Example 1, SELDI-TOF techniques are applied to serum and statistical methods to generate a protein profile associated with a particular disease state, e.g., rheumatoid arthritis, that is useful for diagnostic and prognostic evaluation, e.g., of rheumatoid arthritis. Protein profiles obtained by the methods of the invention are valuable tools to facilitate predicting the outcome of arthritis. Using the methods and protein profiles of various embodiments of the instant invention, patients with rheumatoid arthritis can be distinguished from healthy controls and from patients with inflammatory or other arthritis diseases.

A. Materials and Methods

Patients

A total number of 103 serum samples from patients affected by various pathologies and from healthy controls were collected at the University Hospital of Liege from 2002 with approval from the University Hospital of Liege Ethic Committee. Among these blood serum samples, 34 were obtained from rheumatoid arthritis patients. All the rheumatoid arthritis patients were defined according to the 1987 ACR criteria [19], and where the prognosis was performed according to “patient history, physical examination, laboratory testing (detection of IgM-RF) and radiographs of hands and feet.” An anti-CCP2 antibody ELISA (Immunoscan rheumatoid arthritis Mark 2; Euro-Diagnostica, Arnhem, The Netherlands) was performed according to the manufactorer's instructions with a cutoff at 5 units (sensitivity 80%, specificity 97%). The inflammatory control group consisted of 20 patients having psoriatic arthritis (PsA), 9 having asthma and 10 having Crohn's disease. The non-inflammatory control group consisted of 14 patients having osteoarthritis (OA) and 16 unaffected healthy persons. Complete pathologic analysis was available for all of the rheumatoid arthritis patients and for the 53 diseased patients of control groups. Control sera were selected on the basis of a match for age, sex and race (Caucasian).

Serum samples were collected into a 10 ml Serum Separator Vacutainer Tube and centrifuged at 3,000 rpm for 10 min. All sera were aliquoted and frozen at −80° C. until thawed specifically for immediate use in SELDI analysis. A quality control serum sample was taking from a healthy control. This quality control serum was used to determine reproducibility and as a control protein profile for each SELDI experiment.

ProteinChip Array Preparation and Analysis

Several chip arrays (from Ciphergen Biosystems, Fremont, Calif., USA), including strong anion-exchange (SAX), weak cation-exchange (CM10) and hydrophobic (H4) arrays, were tested in order to determine which would provide the optimal profile, in terms of number and resolution of peaks, for use with serum. Optimization for each array was carried out. For example, the pH (from 3 to 9) and the salt concentration (from 30 mM to IM) of washing buffers were optimized for the ion-exchange arrays. The percentage of acetonitrile (ACN) (from 10 to 60%) was optimized for the H4 array. The CM10 and H4 chip arrays were ultimately determined to give the best results.

Prior to sample loading, each spot of the H4 arrays were circled with a PAP pen (Zymed Laboratories, CA, USA). The CM10 and H4 arrays were activated with 10 μL of 10 mM HCl and 5 μL of ACN, respectively, and equilibrated with 10 μL of binding buffer (100 mM Acetate, 30 mM NaCl, pH 4 for CM10 and PBS, ACN 10%, TFA 0.1% for H4) for 5 min. Serum samples for SELDI analysis were prepared by diluting 10 μL of serum with 40 μL of 100 mM Acetate buffer (pH 4) for the CM10 array experiments, and with 340 μL of PBS, ACN 10%, TFA 0.1% for the H4 array experiments. 5 μL of each diluted serum mixture was applied, in duplicate, to a protein chip array and incubated for 1 hour at room temperature. After discarding the remaining sample, the CM10 and H4 arrays were washed four times and two times, respectively, with 10 μL of binding buffer for 5 minutes, followed by two (for CM10) and four (for H4) brief DI water rinses. The chips were air-dried and stored in the dark at room temperature until subjected to SELDI analysis.

A matrix solution o-cyano-4-hydroxybcinnamic acid (CHCA) was prepared according to the manufacturer's instruction (Ciphergen Biosystem Inc.) in 50% v/v ACN, 0.5% trifluoroacetic acid. Before SELDI analysis, 1 μL of the saturated CHCA solution was applied onto each CM10 spot, and 1 μL of a 1:2 dilution was deposited twice onto each spot of the H4 array, and were allowed to air dry.

Chips were read on a Protein Biological System II Protein Chip reader (Ciphergen Biosystems, Inc). All spectra were acquired in a positive mode and generated by averaging 130 laser shots at a laser intensity of 200 and 210, and a sensitivity of 8 and 9, for the CM10 and H4 arrays, respectively. The focus center was of 10250 Da.

Mass accuracy was calibrated externally using the All-in-1 peptide molecular mass standard (Ciphergen, Biosystem, Inc) complemented by Myoglobin (MW=16951.5) and Cytochrome C (MW=12360) in order to cover a larger range of mass (0 to 20,000 Da). A calibration was carried out according to the manufacturer's instructions.

Preprocessing

Several processing steps are required before data analysis such as baseline subtraction, normalization or peak detection. Baseline subtraction was achieved by employing a varying-width segmented convex hull algorithm that eliminates any baseline signal caused mostly by matrix distortions [as described in Fung E T, Enderwick C. ProteinChip clinical proteomics: computational challenges and solutions. Biotechniques 2002; Suppl: 34-8, 40-1.]. Normalization is essential to eliminate any systematic effects between samples due to varying amounts of protein or degradation over time in the sample or variation in the instrument detector sensitivity. All data were normalized according to the total ion current normalization function by following the software instruction. The part of the spectrum corresponding to n/z values<1000 was not used for analysis, as the energy absorbing matrix signal generally interfered with peak detection in this area. All in all, a spectrum is still represented by about 15,000 m/z values. Due to biological and/or technical reasons, there are further variations in the exact horizontal position of the same biological peak from one spectrum to another. Thus, further pre-processing is necessary to reduce the dimensionality of the data and to take this noise into account. Two different approaches were considered.

First, peak detection was performed using the ProteinChip Biomarker software version 3.0 (Ciphergen Biosystems, Inc.). Peaks having an m/z ratio between 1000 and 20,000 were autodetected with a signal:noise ratio>3 and the peaks clustered using second-pass peak selection with a signal:noise ratio>2 and a 0.3% mass window.

In the second approach, the m/z axis was divided into non-overlapping intervals, the sizes of which are increasing proportionally with the m/z values, and the intensity associated to each interval was taken as the sum of the intensities over the interval. The size of an interval starting at mass m is computed as m. r. r is thus a parameter that determines the resolution of the data and hence the number of inputs that are used for the statistical analysis. Three values of this parameter were tried: 0.3%, 0.5%, and 1%. Unlike peak detection as carried out with the ProteinChip Biomarker Wizard software, this second approach does not imply any filtering of the peaks; all m/z intervals are conserved as inputs for the statistical analysis.

Data Analysis

The data was analyzed by a machine learning algorithm called decision tree boosting.

i. Decision Tree Boosting.

The decision tree method (Breiman et al., Classification and regression trees. In: Wadsworth International, California, 1984) is among the most popular learning algorithms and it has already been used to analyze SELDI-TOF measurements (A. J. Rai et al., Arch Pathol lab Med., 126:1518-1526, 2002; B. L. Adam et al., Cancer Res., 62:3609-3614, 2002). A decision tree is a classification model represented by a tree where each interior node is labeled with a test that compares an m/z value to an intensity threshold and each terminal node is labeled with the name of a class. To retrieve the classification of a new patient described by its (pre-processed) mass spectrum, it is propogated into the tree by answering to the tests until a leaf node is reached and classify this patient according to the class-label attached to this leaf.

One drawback of this method is that it is highly unstable. A small modification of the set of patients may lead to a quite different tree. Hence, the prediction given by a single decision tree may not be very reliable. This instability translates into an accuracy usually lower than other machine learning algorithms. One very efficient way to circumvent this instability and improve decision tree accuracy is the ensemble method. It builds several trees instead of only one and defines a classifier by aggregating classes predicted by these trees: the classification attributed to a new patient is represented by the majority class among classes predicted by all trees of the ensemble for this patient.

Many tree-based ensemble methods exist. For example, single trees with four different ensemble methods, namely bagging, boosting, random forests, and extra-trees, have been compared on two different problems (cf. example 2). In this example, only decision tree boosting which gave competitive results with the other ensemble methods was considered. Boosting is a standard method (T. Hastie, et al. The elements of statistical learning: data mining, inference and prediciton, 2001) that builds the ensemble of trees in sequence. Each tree of the sequence focuses on the samples that are misclassified by the previous trees of the ensemble. More precisely, an Adaboost algorithm was used as described in Freund and Schapire (In: Proceedings of Second European Conference on Computational Learning Theory 1995, p. 23-27) with CART-like trees (L. Wehenkel. Automatic learning techniques in power systems. In: Kluwer Academic, Boston, 1998). Ensembles of 100 trees were constructed.

ii. Evaluation of Sensitivity and Specificity.

To obtain an unbiased estimate of the sensitivity and specificity of a diagnosis provided by the boosting algorithm, leave-one-out cross-validation was used in the learning set of patients. With leave-one-out, an unbiased diagnostic is obtained for each patient by removing all information concerning this patient (i.e. its two spectra) from the learning sample, building a model using the boosting algorithm from the remaining mass spectra, and then classifying this patient using the boosting model. As a patient is described by two spectra, a diagnosis may be given in two ways using the boosting model: by classifying its two spectra independently from each other or by combining the classification of its two spectra. In the first case, the sensitivity is estimated by the proportion of the 68 spectra from 34 RA patients that are well classified by the boosting classifier and the specificity by the proportion of the 138 spectra of 69 patients from the control group that are not RA diagnosed. In the second case, since the primary objective is to maximize sensitivity, a patient is diagnosed with RA as soon as one of its spectra is classified as RA by the boosting classifier. Otherwise, it is diagnosed as non RA. The sensitivity with the two combined spectra is then estimated by the proportion of RA patients well classified according to this rule and the specificity by the proportion of patients from the control group that are not RA diagnosed.

iii. Biomarker identification. As a first step to identify the proteins that are potentially involved in the RA, we need to find m/z peaks or intervals that are responsible for differentiating RA vs. control spectra. Biomarkers can be identified individually or by a multivariate analysis.

a. Single biomarkers. The classical statistical approach to determine the influence of the classification on the intensities of some m/z values is to use some statistical test to determine whether or not the distribution of the intensities at this position is significantly different from the RA to the control groups. The result of this analysis is a p-value that determines the probability of getting a more significant difference than the observed one according to the statistical test. Hence, m/z values corresponding to small p-values highlight significantly different protein concentrations between the two groups. Following the approach adopted in (Fung and Enderwick, Biotechniques, Suppl: 34-38, 40-31, 2002), the discriminative power of peak values and m/z intervals was assessed according to a non parametric Mann-Whitney test.

b. Multivariate analysis. One important characteristic of decision trees is that it is possible to compute from a tree the relative relevance or contribution of each attribute to the classification. This measure gives for each attribute the percentage of information provided by the tree about the classification that can be attributed to this attribute. The relative contribution of an attribute to an ensemble of trees can then be obtained by averaging its relative contributions over all trees of the ensemble. Like the p-value, this measure allows m/z values to be ranked according to their relevance for differentiating the disease and control groups. However, unlike the p-values approach, which considers each attribute individually, this approach considers all attributes simultaneously and hence it can take into account interactions among attributes. Both approaches may thus provide substantially different results. The attribute importance measure for a tree that was used in this Example is the Shannon information measure taken from (L. Wehenkel. Automatic learning techniques in power systems. In: Kluwer Academic, Boston, 1998), and which is described in detail herein.

B. Optimization of Experimental Conditions and Evaluation of Reproducibility

Several parameters have a large influence on the reproducibility and number of peaks detected in protein profiles, and thus need to be optimized. Accordingly, optimal conditions were selected based upon the number and resolution of peaks. In order to simplify the procedure and obtain good reproducibility, serum samples were not fractionated.

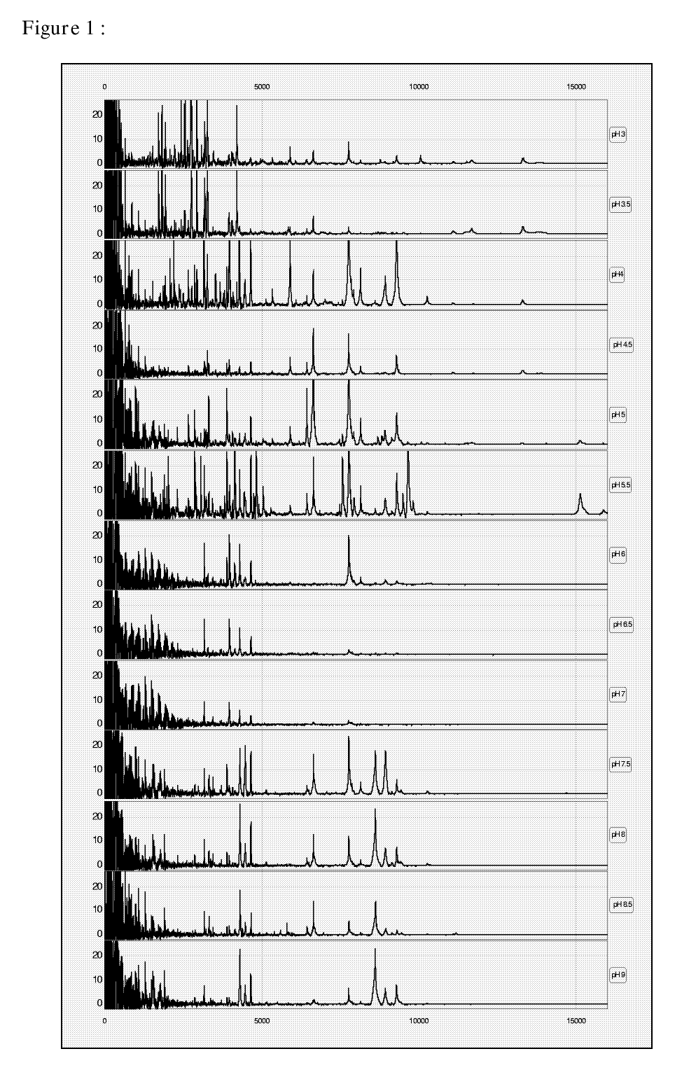

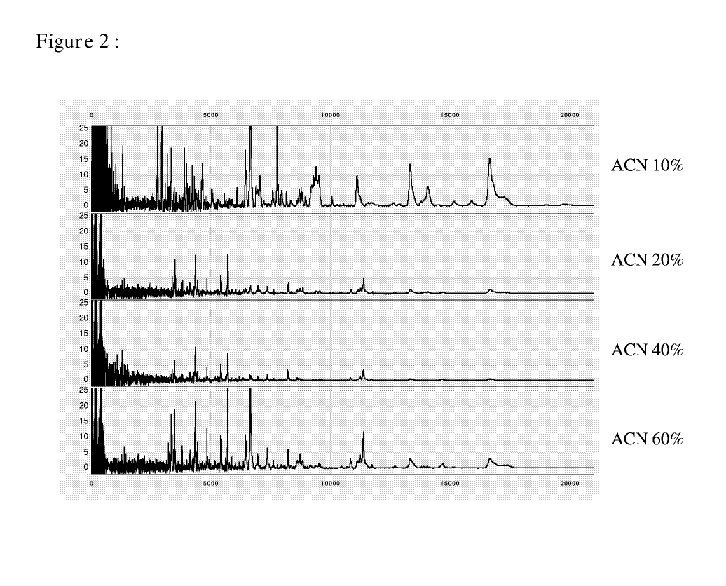

In an effort to increase the volume of the proteome examined and to enhance the chance of detecting protein biomarkers, 103 serum samples were analyzed in parallel on two types of surfaces. Protein profiles of the 103 sera were obtained on CM10 (anion exchange) and H4 (hydrophobic) arrays. Anion exchange arrays (SAX) were also tested but were found to give less desirable results. Each type of ProteinChip Array surface retained different groups of proteins depending on the array's surface properties. The amount of proteins loaded onto the arrays was first optimized by diluting the serum from 1- to 70-fold in the corresponding binding buffer. A 5× and 35× dilution step was selected as an optimal condition for the CM10 and H4 arrays, respectively. In a second step, several pH values (from 3 to 9) with CM10 arrays, and acetonitril percentage (from 0 to 60%) with H4 arrays, were tested in the washing buffers in order to study the binding capacity of and the protein affinity for the arrays. Conditions of pH 4 and 10% acetonitril were finally chosen as optimal conditions for serum analysis (FIGS. 1 and 2).

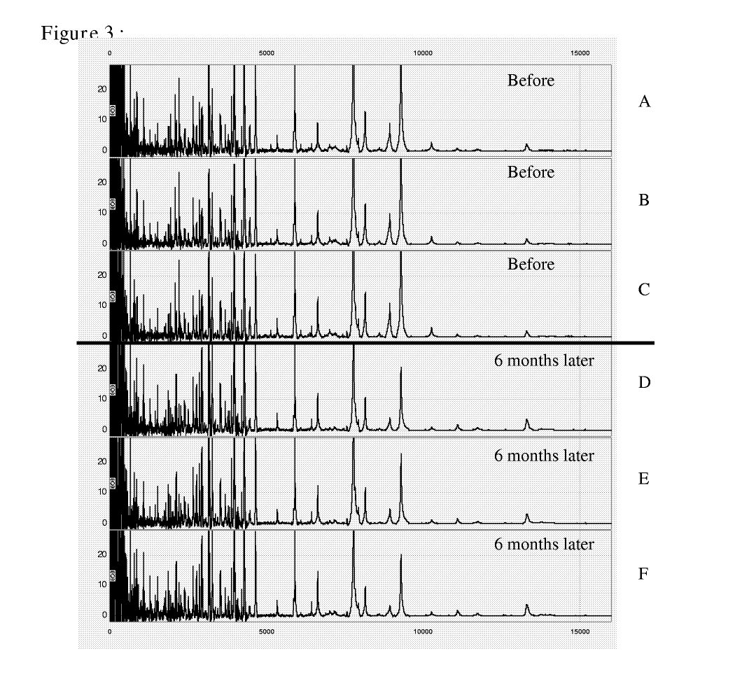

Chips of the 103 serum study were read over the course of a week in order to limit variability across time. Standardization of experimental conditions was carried out in an effort to minimize the effects of irrelevant sources of fluctuation, and coefficient of variations (CVs) were calculated to evaluate the reproducibility of experiments using the SELDI-TOF-MS approach. These CV values were obtained by dropping a quality control (QC) serum sample on 8 spots of CM10 or H4 arrays according to the protocol described above in Patients and Methods. The procedure was performed at the beginning of the study of the 103 serum samples and again 6 months later. CVs were calculated after the normalization process by comparing ten common peaks selected throughout the 8 spectra collected from the same array in regard to their peak intensity. CVs were also established by comparing inter-chip variation at an interval of 6 months. Intra-variation of CM10 and H4 arrays were evaluated to 9% and 16.6%, respectively, at the beginning of the study and, 12% for CM10 six months later. Inter-chip variation across the time was determined at 20% for CM10. FIG. 3 shows three of the eight spectra collected on CM10 at the beginning of the study and 6 months later.

The number of samples and types of samples are other important parameters that determine the success of the method. At least 30 samples were standardly profiled in each classification group (e.g., disease versus healthy or treated versus untreated). This number of samples was sufficient to give >90% statistical confidence in a single marker with p-values<0.01, and was also enough to use different forms of multivariate analysis.

C. Data Analysis

Exchange ion and hydrophobic ProteinChip arrays were observed to give the best results in terms of the number and resolution of peaks (see FIGS. 1 and 2). A total of 206 spectra (as each serum sample was applied in duplicate) were collected on CM10 arrays (anion exchange surface) and H4 arrays (hydrophobic surface). Peak detection and alignment resolved 140 peaks on CM10 arrays and 104 peaks on H4 arrays in the mass range of 1-20 kDa. On the other hand, the proportional integration of the mass range yielded 1026, 628, and 319 mass intervals for r=0.3%, 0.5%, and 1%, respectively. This corresponds in each case to the number of input attributes provided to the boosting algorithm. Using this approach, several biomarkers were identified as specific biomarkers to rheumatoid arthritis on each array. The sensitivity of this method was calculated and found to be higher than the anti-CCP antibodies test.

A set of experiments was carried out involving two different approaches. In a first approach, rheumatoid arthritis spectra were compared to control spectra (including inflammatory controls and non-inflammatory controls). Table 1 shows the sensitivity/specificity values estimated by leave-one-out with decision-tree boosting on both surfaces with different values of r and integrated peaks. A sensitivity superior to 75% and 85% in classifying individual spectra was obtained on CM10 and H4 arrays respectively. Taking into account the two spectra corresponding to a patient, the sensitivity rose to 85% and 95% respectively while specificity slightly decreased (see Table 1).

In a second approach, RA spectra were compared to psoriatic arthritis (PsA) spectra. As indicated in Table 2, sensitivity reaches 89% on CM10 and 94% on H4 arrays. Again, combining the duplicates improved sensitivity but this time decreased significantly specificity.

Table 3 presents the m/z ranges identified by the statistical analysis as the most discriminant values to distinguish the four groups of patients: RA, PsA, inflammatory controls and non-inflammatory controls. These values thus include biomarkers not only related to RA but also to the other diseases in the control groups. These values were compared to the values obtained with the p-value approach. Some correlation between the two approaches was observed. For example, several discriminatory values obtained by boosting also have a very low p-value (10⁻⁹). On CM10 arrays, for example, m/z=10832 has a p-value of 8×10⁻¹⁰. Similarly, on H4 arrays, m/z=2924 has a p-value of 0 and m/z=5686 has a p-value of 4.1×10⁻⁹.

Tables 4 and 5 present the twenty most discriminant m/z intervals or peaks provided by the boosting algorithm for r=0.3%, r=0.5%, and integrated peaks, for differentiating RA vs. the whole control group and RA vs. PsA, respectively. This time, these intervals or peaks are all specific to RA (vs control or vs PsA). For each m/z value, the first number represents the percentage of information attributed to this value (these numbers sum to 100% over all attributes) based on the multivariate analysis. The second number is the rank of this m/z value when all m/z values are ordered according to their relevance for differentiating the disease from the control groups. It is determined by the p-value. It was observed that the most discriminant m/z values according to the multivariate analysis are not necessarily the same as the ones provided by the p-values. This is especially noticeable on CM10 in Table 4, where the most discriminant mass range according to boosting (around 1810 Da) is not well ranked according to the p-values. The two pre-processing also highlight different m/z values. For example, on CM10, the most discriminant attribute with r=0.3% and r=0.5% does not appear in the twenty most important values with integrated peaks.

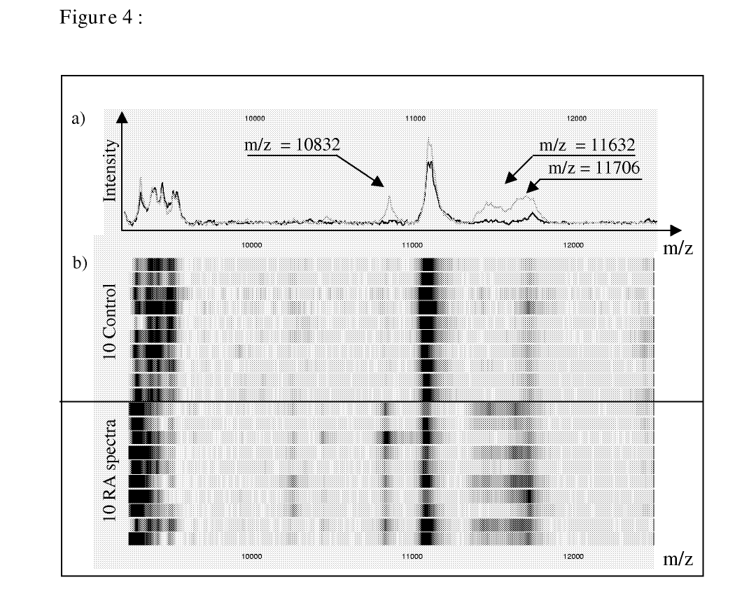

There are also some strong correlations between the two approaches. For example, the m/z range around 2924 Da is considered as the most relevant value for discriminating RA versus control (on H4) by both approaches. This is also the case of m/z=10832 for discriminating RA versus control on CM10 arrays (FIG. 4 illustrates this potential biomarker).

E. Discussion

Example 1 describes the application of methods of the invention to identify new biomarkers associated with an inflammatory disease, e.g., rheumatoid arthritis, using SELDI-TOF-MS. The use of single biomarkers in clinical diagnosis is often limited. Differences in biomarker patterns between disease and control data may complement an individual biomarker. This approach may increase the sensitivity and specificity of the test and may provide a more accurate diagnosis.

Optimization

SELDI-TOF is a new proteomic approach that allows the analysis of multiple serum samples in a relatively short time. This analysis is based on a comparison of the proteomic profile between two sample groups. Upregulated or downregulated proteins are identified and characterized as potential biomarkers according to several statistical analysis. However special care must be applied in order to optimize the reliability and reproducibility of proteomic patterns obtained by SELDI-TOF-MS. Indeed, variations due to numerous sources, including sample collection, sample storage and sample processing, can be problematic [as already described in Baggerly K A, Morris J S, Coombes K R. Reproducibility of SELDI-TOF protein patterns in serum: comparing datasets from different experiments. Bioinformatics 2004; 20:777-85; and in Diamandis EP. Mass spectrometry as a diagnostic and a cancer biomarker discovery tool: Opportunities and potential limitations. Mol Cell Proteomics 2004], giving rise to the identification of artifacts. Hence, impact of freeze-thaw cycles on protein profiles must be considered, standard protocols must be developed to minimize unwanted fluctuation, and coefficients of variation between protein chips must be calculated by using common peaks across different spectra. Chip variability was controlled by using chips from the same lot and chemicals used during the same experiment were from the same batch. Matrix composition and instrument settings are extrinsic factors that also influence reproducibility and must be optimized. Calibration of the instrument must be made frequently. Finally, normalization, baseline subtraction and peak detection are processing steps that must be well carried out.

In the experiments described above, great care was taken to avoid variation in the procedure. For example, freshly collected sera was immediately aliquoted, stored at −80° C. and only thawed once. Quality control serum allowed the detection of any unusual features during the process. Such precautions allowed for very good repeatability and reproducibility between results (see FIG. 3).

Moreover, patients with a variety of very close pathologies to rheumatoid arthritis (OA, PsA) were included in the control groups to mimic real life diagnostic difficulties. Heterogeneous control groups were included, in order to be able to differentiate markers that are inflammatory in nature from rheumatoid arthritis specific molecules.

Statistics

One of the challenges in the analysis of SELDI mass spectrometry-generated data is avoiding the false discovery of proteins peaks, of which the discrimatory power is due to random variation. A safeguard against this problem lies in the choice of the machine learning algorithm and the validation method. Several decision tree based ensemble methods were tried, and boosting was found to be among the best alternative for this kind of problem. The K nearest neighbors method and support vector machines with linear kernel were also applied, but none of these methods was able to reach the same level of sensitivity and specificity as decision tree boosting. Furthermore, a very important advantage of boosting, and other ensemble methods with trees, for this application is that it is possible to estimate from the trees the contribution of each attribute to the classification. Although single decision trees are also able to select relevant attributes, the ranking provided by an ensemble of trees is usually much more robust.

Special care was also taken in the choice of the validation method. Leave-one-out cross-validation ensured that an unbiased estimate of the sensitivity and specificity of our classifier was obtained. Pre-processing is also an important step to avoid the detection of artifacts. Although quite rudimentary, the simple integration of the spectrum gives better performance than the more complex peak detection and alignment procedure. A value of r=1% usually gave the best sensitivity and specificity values. It should be noted, however, that these mass intervals are too high to identify just a single biomarker with sufficient accuracy for further analysis. As a result, the lower values of r=0.3% and r=0.5% are preferred for this task.

The inferior performance of peak detection and alignment software may be explained by two points. First, boosting is quite robust in the presence of noisy attributes and peak detection is not so crucial with this method. Second, peak detection and alignment seem to filter out important biomarkers. For example, the best m/z value on CM10 for discriminating RA vs. control is 1816 Da, which does not appear among the 140 peaks found by the Biomarker Wizard software. This may also explain the differences between the biomarkers found by both approaches.

The comparison between boosting attribute ranking and p-values shows the interest of a multivariate analysis to identify biomarkers. Indeed, the discriminative power of some m/z values only appears when they are combined with each other. These attributes that correspond to large p-values can only be found by a multivariate analysis. The analyses with boosting as presented in Table 4 and 5 highlighted several such values that are worth further consideration.

In this example, all samples were examined in duplicate. The results with boosting showed that the combination of two spectra per patient at the time of the diagnosis can improve the sensitivity significantly without losing too much specificity. It is envisioned that increasing the number of replicates per patient could improve further the quality of the diagnosis. Furthermore, by changing the number of RA predictions required to assign a patient to the RA group, different tradeoffs between sensitivity and specificity may also be realized.

Comparison with Existing Biomarkers

While anti-perinuclear factor (APF) and antikeratin (AKA) are specific to rheumatoid arthritis, their sensitivity toward this pathology remains between 49-91% for APF antibodies and 36-59% for AKA. Both antibodies are detected by indirect immunofluorescence (IIF). Antibodies for APF are found inside the keratoyalin granules of human buccal mucosa epithelium and antibodies to AKA are in the stratum corneum of various cornified epithelia.

Linear synthetic peptides containing the unusual amino acid citrulline were shown to be reactive with rheumatoid arthritis autoantibodies in 76% of rheumatoid arthritis sera, and with a specificity of 96%. Based on these results, an ELISA test based on cyclic citrillinated peptide (CCP) was developed. However, this ELISA test has not consistently improved the sensitivity of the rheumatoid arthritis diagnosis.

The SELDI-TOF approach provided in various embodiments of the instant invention is more specific and sensitive than the lastest anti-CCP commercialized kit for identifying rheumatoid arthritis patients. Indeed, a sensitivity of 85% and a specificity of 91% was obtained with the 2 independent spectra approach on H4 arrays. The sensitivity can even increase to 97% with the alternate approach. Elevated statistical data were also observed in the comparison of the RA and PsA group, despite the similarity of these two pathologies.

Blind Experiments

Evaluation of the classifiers by cross-validation analysis offers some degree of statistical confidence of the potential of this approach as a rheumatoid arthritis detection tool.

Comparison with Other Proteomic Approaches

2-DE is the most established method in proteomics for its separation power and its ability to determine post-translational modifications. This method, however, seems to encounter several limitations in differential display proteomic studies due to its lack of gel-to-gel reproducibility. Moreover, the method is time consuming, a vast number of proteins with a molecular weight less than 10 kDa cannot be analyzed and it requires a large amount of sample. In addition, low abundant, acidic, basic or membrane proteins are generally not detectable by using 2-DE.

Ion exchange followed by on-line RP-HPLC-MS has obtained a great success in identifying proteins in complex mixtures after tryptic digestion. With this method, however, it is difficult to obtain information about the expression level of proteins between samples unless the proteins are first labeled by isotope-coded affinity tags or other protein labeling techniques. Furthermore, it requires time and has limited throughput.

In contrast to the above methodologies, the ProteinChip technology is fast, has high throughput capability, requires orders of magnitude lower amounts of protein sample and is directly applicable for clinical assay development. The platform's powerful advantages save time and sample amount. SELDI profiling alone should permit accurate diagnosis without identification of protein peak identity. It will be understood, however, that the purification and subsequent identification of a limited number of rheumatoid arthritis biomarkers identified by the methods provided herein may further facilitate the understanding of the disease and the development of an antibody-based clinical test. Nevertheless, a serum-based marker panel as provided herein should have sufficient sensitivity and specificity to facilitate the screening of individuals at high risk of developing a rheumatoid arthritis.

Conclusion for Example 1

The capability of the ProteinChip technology for rapid biomarker discovery from crude serum sample has been demonstrated by the Examples set forth above.

Comparison of rheumatoid arthritis versus inflammatory and non-inflammatory serum sample provided an effective approach to screen potential biomarker candidates. A future identification of those biomarkers will allow an even greater understanding of the disease.

### Example 2

The aim of this example is to illustrate the different steps of the method of the present invention for determining classifier and biomarkers for a biological condition. Example 2 provides results of using a method of the present invention using two datasets of experimental studies based on surface-enhanced laser desorption/ionization time of flight (SELDI-TOF) measurements. The first dataset concerns the diagnosis of patients suffering from rheumatoid arthritis (RA). The second dataset concerns the diagnosis of inflammatory bowel diseases (IBD), i.e. Crohn's disease and Ulcerative colitis. In Example 2, ensembles of 100 trees are used.

Example 2 also compares a discretization approach to selecting input attributes with the peak detection and alignment software developed by the manufacturer of the SELDI-TOF device used (ProteinChip Biomarker Software version 3.0 by Ciphergen Biosystems, Inc.). This Ciphergen algorithm filters out m/z values that do not contain a “real peak” in at least one spectrum in the dataset and aligns the spectra so that their peaks correspond to the same (corrected) m/z value.

A. Datasets

Experiments were carried out on two datasets. Each dataset consists of SELDI measurements obtained from serum samples of several patients. In both datasets, the main goal is to detect patients suffering from one particular inflammatory disease: rheumatoid arthritis (RA) for the first dataset and inflammatory bowel disease (IBD) in the second one. In both cases, the control group is composed of samples of healthy patients and patients affected by different inflammatory diseases. These samples were collected at the University Hospital of Liege from 2002 until present. In the first problems, each blood sample has been analysed twice. In the second problem, each blood sample has been analysed four times. The composition of each dataset in terms of the number of spectra in the target and the non target classes is given in Table 6. In both cases, several chip arrays were tested. Results of this example were obtained on hydrophobic (H4) arrays for the RA study and on weak cation-exchange (CM10) array for the IBD study. Mass spectra were obtained from chip arrays by a PBS II Protein Chip reader (Chiphergen Biosystems Inc.). Several standard spectra processing steps (e.g., baseline substraction, normalization.) were applied to the resulting spectra before applying the step of selecting input attributes according to the present invention or prior to peak selection. In both cases, four values of the parameter r: 0.0%, 0.3%, 0.5%, and 1% were tried and peak alignment and selection was as carried out by the ProteinChip Biomarker Software version 3.0 (Ciphergen Biosystems, Inc.). The resulting number of input attributes in all cases is given in Table 6.

B. Results on Raw Discretized Data and on Selected Peaks

Table 7 shows the results obtained by all machine learning algorithms on the two problems with discretized spectra. The “best” results in terms of error rate according to the discretization percentage r are presented. The “best” value of r for each method and each dataset is given in the table in the columns labeled r*. Table 8 reports the results obtained with pre-processing by peak alignment and detection. Sensitivities, specificities, and error rates (in %) in these tables are estimated by leave-one-out cross-validation. However, as the learning sets contain several (two or four) measures for each patient, all measures corresponding to a particular patient are removed in each leave-one-out round so as not to bias the estimates. The results in Tables 7 and 8 concern the post-merging method (using the full class information during learning). On RA, the “best” results is obtained with boosting. On IBD, the “best” method is extra-trees. On both problems, ensemble methods are quite close but single trees are clearly inferior. Using the data pre-processed by peak selection gives slightly less good results on both problems. In the case of the pre-processing by discretization, a value of r=1% worked better on both problems. Table 9 shows the evolution of the error with the parameter r on RA with boosting and on IBD with extra-trees. In both cases, the error decreases as r increases, showing the interest of the discretization. From the point of view of computing times, using r=1% instead of r=0% also makes the computation of one model more than 40 times faster. Indeed, the complexity of decision tree methods is linear with respect to the number of attributes and this number is divided by about 40 when going from r=0% to r=1% (see Table 7).

For comparison, Table 10 reports the results obtained when considering only two classes during the learning phase (i.e. pre-merging). Pre-merging slightly improves the results in single decision trees but is significantly detrimental in the case of the ensemble methods. All in all, we conclude that post-merging is better than pre-merging in these problems.

C. Attribute Importance Ranking

Table 11 gives for each problem the m/z interval and percentage of information (i.e. the importance) of the first ten attributes respectively ranked by a single CART tree and by boosting, with discretization (r=1%) and also with peak detection. The table also provides the ranking (Rank) of each attribute according to the p-values obtained by a statistical non parametric Mann-Whitney test.

We notice that rankings of the single tree and boosting models are quite different, but since the latter is much more accurate than the former, we deem its attribute ranking also more reliable. We also observe that “peak detection” and our discretization method give different rankings. We believe that peak detection removes some important attributes that the machine learning methods have to replace with other (less informative) attributes, and so changes the order of rankings. Actually, on both problems the most important attributes (with boosting) correspond to two m/z ranges (1054-1064 on RA and 5177-5230 on IBD) where no peak was found by the peak detection method. Thus, the first m/z value detected by the boosting model with the peaks is only the second on RA and the third on IBD attribute in the ranking obtained with the discretization r=1%. This may also explain the difference in error rates between Table 7 and Table 8.

While in Table 11 the first attribute given by the importance measure derived from machine learning models is (in every case) also ranked high (among the top 3 and most often first) according to the p-values, some important attributes are ranked rather low by these latter. This is explainable by the fact that the p-values detect only single-variable effects while the importance ranking is a multivariate approach and therefore can detect interacting effects of several attributes.

D. Iterative Biomarker Identification

In Table 11, the first ranked attribute dominates the others but the importance of the following variables decreases slowly. Hence, such a ranking does not necessarily make appear a clearly defined group of biomarkers. To complement this ranking, an embodiment of the present invention using an iterative biomarker identification method was applied, where the attributes are first ranked according to their importance in the best classifier determined by leave-one-out cross-validation. The steps of determining classifiers, evaluating them and selecting them are then repeated using only the top ranked attributes while progressively increasing their number. The accuracy estimates (e.g., by cross-validation) of the resulting sequence of models provides a learning curve which typically first increases then reaches a maximum and decreases. The attributes corresponding to the maximum accuracy are then retained as the candidate set of attributes, from which a set of one or more biomarkers is determined.

On each problem, attribute importance was computed by boosting with the optimal value of r and then all algorithms were rerun with the same value of r on the top N ranked attributes. Table 12 shows the results obtained with increasing values of N going from 1 to 100. In each case, the “best” results among all methods (according to error rate) are reported. The last line of Table 12 corresponds to the results from Table 7, where all attributes are kept. In both cases, the accuracy goes through a minimum when N increases and attribute selection improves the accuracy (comparing the bold underlined values to the last line of the table) while at the same time reducing the number of attributes.

In both problems, this exact minimum corresponds to a quite large number of attributes (respectively, 20 and 75 attributes). However, the most important decrease of error occurs in all cases with a smaller number of attributes. On RA, there is an important improvement when going from 5 to 10 attributes. On IIBD, about 15 to 20 attributes already lead to very acceptable results.

E. Aggregation of Replica Classifications

Until now, accuracy was estimated, in this Example, on the task of classifying a patient from only one of its spectra. However, when several measurements are available for the same patient, it is possible to take into account these multiple replicas to improve accuracy. Table 13 shows the results of an aggregation approach on the IBD dataset where four measurements are available for each patient. A model for classifying each measurement is built using the same approach as in previous experiments. Then, the four measurements corresponding to a patient are classified by this model and the patient is classified in the target class only if at least M of his measurements are classified in this class. By increasing the value of M, it is possible to favor classifications in the target class and thus to provide different tradeoffs between sensitivity and specificity.

Table 13 shows the results obtained with this approach for increasing values of M, in the top by using all attributes and in the bottom by using the first 50 attributes selected by boosting. In both cases, boosting with r=1% was used. In both cases, this aggregation of the classifications improves the sensitivity and the specificity with respect to the use of only one measurement per patient. The “best” compromise in terms of error rate is obtained by taking M=2. With all attributes, the error rate goes from 10.44% to 7.5% and with 50 attributes, the error rate goes from 7.31% to 4.17%.

### Example 3

In Example 3, SELDI-TOF techniques are applied to serum and statistical methods to generate a protein profile associated with particular diseases state, e.g., Crohn's disease (C.D.) and ulcerative recto colitis (U.C.), that is useful for diagnostic and prognostic evaluation, e.g., of those inflammatory bowel diseases (I.B.D.). Protein profiles obtained by the methods of the invention are valuable tools to facilitate predicting the outcome of these two diseases. Using the methods and protein profiles of various embodiments of the instant invention, patients with Crohn's disease and ulcerative recto colitis can be distinguished from healthy controls and from patients with other inflammatory diseases.

This proteomic approach attempted to answer three questions regarding the potential interest of proteomics in I.B.D. management. The first being the possibility to discriminate the different classes of I.B.D. versus non I.B.D. inflammatory pathologies affecting or not the bowel and healthy controls. The second one rises up the feasibility to discriminate accurately C.D. from U.C. Finally, many active patients and some in remission were considered and the statistical approach describes in Example 1 was used to discriminate the different classes of I.B.D. cases showing activity.

A. Materials and Methods

Patients

Experimental protocol was approved by ethic Committee of our academic hospital and patient enrolled were informed on the study concept. A total of 150 serum samples from patients affected by various pathologies and healthy controls were prospectively collected in 10 cc Serum Separator Vacutainer Tube and centrifuged at 3,000 rpm for 10 min. All sera were aliquoted and immediately frozen at −80° C., until thawed specifically for S.E.L.D.I.-T.O.F.-M.S. analysis.

The samples were organized in 4 categories according to the pathology considered: Crohn's Disease (C.D), Ulcero Colitis (U.C), Healthy Controls (H.C.) and Inflammatory Controls (I.C.). I.C. were patients presenting inflammatory pathologies affecting the bowel other than I.B.D. as diverticulitis or pathogens caused enterocolitis, as well as two other chronic inflammatory diseases: Asthma and Rheumatoid Arthritis. Diagnosis of I.B.D. patients was realized by gastroenterologists specialized in I.B.D. C.D. were classified as active or inactive according to Harvey-Bradshow index and U.C. were categorized according to the presence of significant lesions after rectosigmoidoscopy including erosion and fibrosis or contact bleeding. Moreover, A.S.C.A. (EUROIMMUN and Medipan) and p.A.N.C.A. (The Binding Site-UK) tests were realized on every sample according to manufacturer recommendations, in order to correlate our results to existing tests. Vienna classification was used to describe the localization and behavior of C.D. population. C.D. and U.C. were selected in a first study with 15 actives cases and 15 patients considered in remission. The H.C. group was composed of 30 “healthy controls” showing C-reactive protein (C.R.P). level <6 mg/l (CRPXL Tina-quant® ROCHE).

Protein Chip Array Preparation and Analysis

A quality control serum sample was collected among the healthy control group in order to determine the reproducibility of the SELDI-TOF-MS procedure. All the steps of the analysis were optimised as described in Example 1 in order to obtain optimal profiles using a standardized procedure. Two kinds of chip arrays were selected for this study: CM10 and Q10 arrays (anions and cations exchangers, respectively). All arrays used in the present example are also from Ciphergen Biosystems, Inc.

Prior loading sample, each spot was activated with 10 μl of HCl 10 mM and equilibrated 5 min at room temperature in 10 μl of binding buffer (100 mM Acetate buffer, 30 mM NaCl, 0.05% triton X-100 (for Q10 only) at pH 4). Sera samples were thawed on ice and then centrifuged 10 min. at 4° C. and finally diluted 5 times in 100 mM Acetate buffer, 0.05% triton X-100 (for Q10 chip only) at pH 4. Five μl of diluted sample mixture was applied on each spot, in quadruplicate. The step of fixation lasted 1 h at 4° C., in a water saturated atmosphere to avoid spots to dry out. After discarding the remaining sample from the spots, several washing steps were realized: 2×10 μl of corresponding binding buffer devoid of NaCl, at R.T., 5 min., 2×10 μl of binding buffer devoid of NaCl and triton X100, 5 min., at RT and finally, 2×10 μl of H.P.L.C. water, 5 min. at R.T. The chips were air dried and stored in the dark at R.T. A matrix solution of a-cyano-4-hydroxycinnamic acid (C.H.C.A.) was prepared according to the manufacturer's instructions (Ciphergen Biosystem Inc.) in 50% v/v A.C.N. and 0.5% trifluoroacetic acid (T.F.A). C.H.C.A. was diluted twice in appropriate buffer and applied on spot in two loads of 1 μl. The chips were air dried at least 30 min. to allow crystals network formation at the surface of the spots.

Chips were read on a Protein Biological System II ProteinChip reader (Ciphergen Biosystems Inc.) in the m/z range 0 to 20,000 Da. Other parameters of reading and calibration were set as already described in Example 1.

B. Results and Discussion

Example 3 describes the application of methods of the invention to identify new biomarkers associated with two inflammatory diseases, e.g., Crohn's disease and Ulcerative Colitis, using SELDI-TOF-MS. The use of single biomarkers in clinical diagnosis is often limited. Differences in biomarker patterns between disease and control data may complement an individual biomarker. This approach may increase the sensitivity and specificity of the test and may provide a more accurate diagnosis. Classification models, scores of specificity and sensitivity Considering the entire database, 120 samples were profiled in quadruplicate and gave a total of 480 spectra. Peak detection and alignment resolved 150 peaks on CM10 and 50 on Q10. Specificity and sensitivity obtained with the incremental pre-processing procedure (cf Example 1) were calculated with the three r values: 0.3%-0.5%-1%, for the comparison: I.B.D versus all controls on CM10. r value at 0.5% was selected for further analysis, as it offers the best compromise and as it is in good agreement with the technology mass resolution (0.2%).

Several groups of spectra were compared: firstly I.B.D. vs. controls, then C.D. vs. U.C., C.D. vs. all other and U.C. vs. all other. Results described in Table 14.a are for the entire set of samples and Table 14.b for the active patients (patients exhibiting the symptoms of the disease). These results were obtained by aggregating the classifications of the 4 spectra corresponding to each patient: a patient being classified in the target disease when at least 3 out of 4 spectra are classified in this disease. A sensitivity ranging from 67% to 90% and from 67% to 97% was obtained on Q10 and CM10 arrays, respectively. Taking into account the active patients only, the sensitivity rose within a range from 53% to 97% on Q10 and from 73% to 97% on CM10. In all cases specificities obtained were excellent (ranging from 87% to 100%) as well as the accuracy (77% to 98%).

Biomarkers Selection

Boosting decision-tree method also provides information about which variable, meaning a peak or a protein, present a high potential of discrimination.

Tables 15 (CM10) and 16 (Q10) present the most discriminant m/z intervals provided by the boosting algorithm and by the p-value analysis. In most cases, univariate analysis confirms the multivariate results with a very low “p-value”. Note that “p-values” inferior to 10⁻¹² are assimilated to 0.

Conclusion for Example 3

The capability of the ProteinChip technology for rapid biomarker identification from crude serum sample has been demonstrated by the Examples set forth above. Comparison of Crohn and Ulcerative Colitis versus inflammatory and non-inflammatory serum samples provided an effective approach to screen potential biomarker candidates.

All literature and similar material cited in this application, including, but not limited to, patents, patent applications, articles, books, treatises, and web pages, regardless of the format of such literature and similar materials, are expressly incorporated by reference in their entirety. In the event that one or more of the incorporated literature and similar materials differs from or contradicts this application, including but not limited to defined terms, term usage, described techniques, or the like, this application controls.

The section headings used herein are for organizational purposes only and are not to be construed as limiting the subject matter described in any way.

While the inventions have been described in conjunction with various embodiments and examples, it is not intended that the inventions be limited to such embodiments or examples. On the contrary, the present inventions encompass various alternatives, modifications, and equivalents, as will be appreciated by those of skill in the art. Those skilled in the art will recognize, or be able to ascertain using no more than routine experimentation, many equivalents to the specific embodiments of the invention described herein. Such equivalents are intended to be encompassed by the following claims.

The claims should not be read as limited to the described order or elements unless stated to that effect. It should be understood that various changes in form and detail may be made without departing from the scope of the appended claims.

TABLE 1
Sensitivities and specificities obtained by boosting analysis on CM10
and H4 arrays for RA vs. controls with different pre-processing

| | With two | | With two | |
|---|---|---|---|---|
| Pre- | independent spectra | | combined spectra | |
| processing | Sensitivity | Specificity | Sensitivity | Specificity |

CM10

| | | | | |
|---|---|---|---|---|
| r = 0.3% | 77.9 (53/68) | 89.9 (124/138) | 88.2 (30/34) | 85.5 (59/69) |
| r = 0.5% | 76.5 (52/68) | 87.0 (120/138) | 91.2 (31/34) | 76.8 (53/69) |
| r = 1% | 77.9 (53/68) | 87.7 (121/138) | 91.2 (31/34) | 84.1 (58/69) |
| Integrated | 69.1 (47/68) | 78.3 (108/138) | 79.4 (27/34) | 75.4 (52/69) |
| peaks | | | | |

H4

| | | | | |
|---|---|---|---|---|
| r = 0.3% | 85.3 (58/68) | 90.6 (125/138) | 94.1 (32/34) | 87.0 (60/69) |
| r = 0.5% | 85.3 (58/68) | 90.6 (125/138) | 94.1 (32/34) | 89.8 (62/69) |
| r = 1% | 83.8 (57/68) | 94.9 (131/138) | 97.1 (33/34) | 91.3 (63/69) |
| Integrated | 80.9 (55/68) | 92.8 (128/138) | 88.2 (30/34) | 89.8 (62/69) |
| peaks | | | | |

TABLE 2
Sensitivities and specificities obtained by boosting analysis on
CM10 and H4 arrays for RA vs. PsA with different pre-processing

| | With two | | With two | |
|---|---|---|---|---|
| Pre- | independent spectra | | combined spectra | |
| processing | Sensitivity | Specificity | Sensitivity | Specificity |

CM10

| | | | | |
|---|---|---|---|---|
| r = 0.3% | 83.8 (57/68) | 61.9 (26/42) | 85.3 (29/34) | 47.6 (10/21) |
| r = 0.5% | 83.8 (57/68) | 64.3 (27/42) | 88.2 (30/34) | 38.1 (8/21) |
| r = 1% | 89.7 (61/68) | 71.4 (30/42) | 85.3 (29/34) | 33.3 (7/21) |
| Integrated | 86.8 (59/68) | 54.8 (23/42) | 94.1 (32/34) | 47.6 (10/21) |
| Peaks | | | | |

H4

| | | | | |
|---|---|---|---|---|
| r = 0.3% | 92.6 (63/68) | 78.6 (33/42) | 97.1 (33/34) | 66.7 (14/21) |
| r = 0.5% | 94.1 (64/68) | 85.7 (36/42) | 97.1 (33/34) | 76.2 (16/21) |
| r = 1% | 89.7 (61/68) | 76.2 (32/42) | 94.1 (32/34) | 71.4 (15/21) |
| Integrated | 94.1 (64/68) | 83.3 (35/42) | 91.2 (31/34) | 71.4 (15/21) |
| Peaks | | | | |

TABLE 3
The ten most discriminant values obtained on CM10 and H4 arrays for
RA vs PsA vs inflammatory controls vs non-inflammatory controls

| | | Integrated | | | Integrated |
|---|---|---|---|---|---|
| r = 0.3% (boost.) | r = 0.5% (boost.) | peak | r = 0.3% (boost.) | r = 0.5% (boost.) | peak |
| CM10 | | | H4 | | |
| m/z | m/z | m/z | m/z | m/z | m/z |
| 1810-1816 | 1807-1816 | 8143 | 3340-3351 | 1444-1452 | 3341 |
| 1816-1821 | 7729-7768 | 10833 | 6181-6200 | 3342-3359 | 4825 |
| 9225-9253 | 8692-8736 | 7565 | 1356-1361 | 4809-4834 | 4538 |
| 8126-8150 | 10813-10869 | 8688 | 3245-3256 | 4785-4809 | 5762 |
| 7734-7758 | 11610-11669 | 7767 | 4744-4759 | 4737-4761 | 5854 |
| 10825-10859 | 12527-12591 | 9287 | 4820-4835 | 1354-1361 | 6684 |
| 9085-9113 | 3819-3838 | 13291 | 4608-4623 | 4595-4618 | 5686 |
| 8671-8698 | 6877-6912 | 17240 | 5831-5849 | 3241-3258 | 10441 |
| 12441-12480 | 2719-2733 | 6948 | 1328-1332 | 1327-1334 | 2924 |
| 3881-3893 | 9096-9143 | 12447 | 4306-4319 | 6178-6210 | 8213 |

TABLE 4
The twenty most discriminant values obtained
on CM10 and H4 arrays for RA vs. controls

| r = 0.3% | | | r = 0.5% | | | Integrated peaks | | |
|---|---|---|---|---|---|---|---|---|
| m/z | % info | Rank | m/z | % info | Rank | m/z | % info | Rank |

CM10

| | | | | | | | | |
|---|---|---|---|---|---|---|---|---|
| 1816-1821 | 10.09 | 594 | 1807-1816 | 15.69 | 74 | 10832 | 8.84 | 1 |
| 1810-1816 | 7.77 | 296 | 11610-11669 | 3.55 | 1 | 1944 | 4.68 | 19 |
| 15764-15812 | 3.11 | 11 | 4084-4105 | 2.72 | 20 | 4668 | 4.44 | 2 |
| 4110-4123 | 2.76 | 16 | 8559-8603 | 2.66 | 127 | 11632 | 4.14 | 3 |
| 11628-11663 | 2.39 | 1 | 11260-11316 | 2.46 | 8 | 5492 | 3.24 | 10 |
| 9141-9169 | 1.79 | 111 | 4105-4126 | 2.11 | 10 | 8563 | 2.95 | 35 |
| 1939-1945 | 1.65 | 45 | 1940-1950 | 1.83 | 86 | 4128 | 2.88 | 4 |
| 5849-5867 | 1.46 | 59 | 5840-5870 | 1.44 | 28 | 11706 | 2.72 | 5 |
| 3111-3121 | 1.43 | 103 | 1467-1475 | 1.33 | 19 | 2900 | 1.69 | 82 |
| 11663-11699 | 1.34 | 3 | 4571-4595 | 1.18 | 53 | 2847 | 1.46 | 49 |
| 10825-10859 | 1.28 | 4 | 15109-15186 | 1.16 | 62 | 7438 | 1.4 | 13 |
| 4653-4668 | 1.2 | 5 | 4761-4785 | 1.06 | 25 | 9499 | 1.35 | 28 |
| 2585-2593 | 1.05 | 380 | 12028-12088 | 1 | 121 | 4095 | 1.33 | 11 |
| 1729-1734 | 0.96 | 6 | 2835-2850 | 1 | 50 | 4076 | 1.26 | 16 |
| 11592-11628 | 0.92 | 2 | 11729-11788 | 0.98 | 4 | 9133 | 1.1 | 37 |
| 11275-11310 | 0.86 | 19 | 4666-4689 | 0.88 | 5 | 8615 | 1.08 | 25 |
| 2360-2368 | 0.8 | 871 | 2415-2428 | 0.83 | 359 | 7641 | 0.99 | 17 |
| 10790-10825 | 0.76 | 39 | 4148-4169 | 0.82 | 266 | 2379 | 0.98 | 90 |
| 10438-10469 | 0.72 | 82 | 14956-15033 | 0.79 | 300 | 2163 | 0.95 | 98 |
| 4253-4266 | 0.72 | 758 | 5063-5089 | 0.79 | 357 | 4264 | 0.93 | 166 |

H4

| | | | | | | | | |
|---|---|---|---|---|---|---|---|---|
| 8052-8076 | 4.19 | 43 | 2924-2938 | 6.15 | 1 | 2924 | 11.38 | 1 |
| 2923-2932 | 4.05 | 1 | 4809-4834 | 4.25 | 356 | 4538 | 7.37 | 44 |
| 1057-1061 | 3.51 | 52 | 2223-2234 | 3.93 | 2 | 10441 | 5.22 | 31 |
| 4820-4835 | 3.21 | 422 | 1059-1064 | 3.29 | 4 | 4825 | 4.42 | 92 |
| 6181-6200 | 2.27 | 165 | 1092-1097 | 2.99 | 23 | 2778 | 4.2 | 21 |
| 10438-10469 | 2.03 | 119 | 1522-1530 | 2.26 | 12 | 5686 | 3.11 | 5 |
| 2227-2234 | 1.89 | 4 | 8053-8094 | 1.72 | 56 | 6669 | 2.29 | 43 |
| 4608-4623 | 1.75 | 13 | 5327-5354 | 1.59 | 20 | 5914 | 2.22 | 54 |
| 4744-4759 | 1.55 | 204 | 1444-1452 | 1.55 | 44 | 1034 | 1.95 | 24 |
| 4534-4549 | 1.54 | 454 | 5579-5608 | 1.48 | 318 | 4134 | 1.94 | 42 |
| 5320-5336 | 1.41 | 12 | 4618-4642 | 1.4 | 172 | 4850 | 1.68 | 61 |
| 2011-2017 | 1.26 | 791 | 3781-3800 | 1.33 | 6 | 8596 | 1.67 | 52 |
| 8589-8617 | 1.26 | 174 | 4595-4618 | 1.21 | 53 | 5058 | 1.63 | 4 |
| 3881-3893 | 1.12 | 38 | 10436-10488 | 1.19 | 72 | 15139 | 1.55 | 14 |
| 1276-1280 | 1.07 | 369 | 15339-15417 | 1.13 | 8 | 5762 | 1.45 | 23 |
| 6539-6560 | 1.07 | 228 | 23101-23218 | 0.99 | 212 | 4592 | 1.44 | 72 |
| 1692-1697 | 1.03 | 105 | 3258-3275 | 0.99 | 137 | 7160 | 1.41 | 83 |
| 5597-5614 | 1.01 | 367 | 5840-5870 | 0.98 | 34 | 8693 | 1.39 | 48 |
| 1061-1064 | 0.99 | 27 | 7729-7768 | 0.97 | 13 | 11686 | 1.35 | 3 |
| 11592-11628 | 0.97 | 51 | 6052-6084 | 0.96 | 130 | 3320 | 1.32 | 32 |

TABLE 5
The twenty most discriminant values obtained
on CM10 and H4 arrays for RA vs. PsA

| r = 0.3% | | | r = 0.5% | | | Integrated peaks | | |
|---|---|---|---|---|---|---|---|---|
| m/z | % info | Rank | m/z | % info | Rank | m/z | % info | Rank |

CM10

| | | | | | | | | |
|---|---|---|---|---|---|---|---|---|
| 5490-5508 | 5.51 | 14 | 2835-2850 | 6.25 | 14 | 4666 | 8.84 | 1 |
| 11031-11066 | 4.23 | 4 | 13177-13244 | 4.86 | 1 | 5492 | 6.42 | 3 |
| 13229-13269 | 3.86 | 3 | 1807-1816 | 4.8 | 319 | 4647 | 3.75 | 6 |
| 4653-4668 | 3.86 | 2 | 3819-3838 | 2.51 | 63 | 3974 | 2.83 | 35 |
| 1816-1821 | 3.36 | 880 | 13515-13583 | 2.25 | 17 | 2261 | 2.59 | 88 |
| 4110-4123 | 2.42 | 126 | 4642-4666 | 2.13 | 9 | 11651 | 2.56 | 24 |
| 3818-3830 | 2.19 | 185 | 21852-21963 | 2.1 | 8 | 2847 | 2.53 | 12 |
| 14731-14776 | 2.17 | 45 | 12591-12654 | 1.76 | 7 | 3551 | 2.33 | 30 |
| 3982-3994 | 1.7 | 55 | 12088-12149 | 1.72 | 96 | 1867 | 2.25 | 36 |
| 2593-2602 | 1.58 | 260 | 4105-4126 | 1.7 | 67 | 3162 | 2.17 | 18 |
| 13189-13229 | 1.54 | 1 | 4666-4689 | 1.66 | 2 | 11079 | 2.14 | 8 |
| 12058-12094 | 1.51 | 37 | 6274-6306 | 1.58 | 32 | 12802 | 2.07 | 52 |
| 2834-2843 | 1.34 | 71 | 22984-23101 | 1.56 | 13 | 7641 | 1.91 | 16 |
| 10122-10153 | 1.22 | 91 | 10980-11035 | 1.54 | 5 | 7565 | 1.88 | 41 |
| 13556-13598 | 1.19 | 15 | 10124-10176 | 1.48 | 95 | 6882 | 1.69 | 73 |
| 6313-6333 | 1.06 | 108 | 3959-3979 | 1.44 | 115 | 9499 | 1.58 | 9 |
| 8454-8481 | 0.97 | 83 | 2879-2894 | 1.37 | 440 | 13291 | 1.58 | 2 |
| 12558-12597 | 0.94 | 33 | 1826-1835 | 1.34 | 72 | 1641 | 1.52 | 74 |
| 1043-1047 | 0.92 | 59 | 14729-14805 | 1.3 | 27 | 16612 | 1.42 | 5 |
| 9113-9141 | 0.91 | 431 | 6434-6467 | 1.3 | 190 | 12599 | 1.41 | 7 |

H4

| | | | | | | | | |
|---|---|---|---|---|---|---|---|---|
| 4820-4835 | 13.13 | 1 | 4809-4834 | 19.27 | 1 | 4824 | 26.32 | 1 |
| 5597-5614 | 5 | 1017 | 4524-4547 | 6.34 | 9 | 5684 | 8.2 | 54 |
| 4534-4549 | 4.72 | 10 | 1059-1064 | 4.75 | 3 | 2924 | 5.39 | 3 |
| 1057-1061 | 3.71 | 25 | 5579-5608 | 3.54 | 461 | 10525 | 4.2 | 42 |
| 6181-6200 | 2.6 | 380 | 1444-1452 | 3.32 | 5 | 2778 | 3.56 | 11 |
| 8052-8076 | 2.5 | 90 | 6877-6912 | 2.17 | 262 | 10441 | 2.93 | 38 |
| 3393-3404 | 2.45 | 56 | 1274-1280 | 2.05 | 34 | 8213 | 2.86 | 13 |
| 3080-3091 | 2.3 | 13 | 2924-2938 | 1.87 | 2 | 5914 | 2.83 | 17 |
| 1061-1064 | 1.89 | 6 | 4298-4319 | 1.82 | 13 | 1034 | 2.42 | 9 |
| 4306-4319 | 1.7 | 8 | 8053-8094 | 1.8 | 91 | 5165 | 2.11 | 35 |
| 1047-1050 | 1.69 | 14 | 2200-2211 | 1.78 | 174 | 4389 | 2.05 | 30 |
| 6896-6918 | 1.66 | 342 | 2953-2968 | 1.65 | 49 | 8693 | 1.86 | 16 |
| 23107-23176 | 1.5 | 9 | 5327-5354 | 1.58 | 7 | 7935 | 1.59 | 5 |
| 24419-24493 | 1.41 | 226 | 4834-4858 | 1.33 | 4 | 3090 | 1.52 | 14 |
| 2412-2420 | 1.39 | 276 | 5221-5247 | 1.27 | 112 | 12841 | 1.51 | 21 |
| 4804-4820 | 1.36 | 2 | 1788-1798 | 1.21 | 396 | 3042 | 1.35 | 27 |
| 4372-4386 | 1.34 | 82 | 3076-3093 | 1.2 | 11 | 15860 | 1.27 | 7 |
| 1272-1276 | 1.22 | 57 | 23101-23218 | 1.05 | 6 | 2024 | 1.19 | 94 |
| 4293-4306 | 1.17 | 94 | 6912-6947 | 0.92 | 541 | 2943 | 1.17 | 8 |
| 6960-6982 | 1.14 | 546 | 15033-15109 | 0.89 | 14 | 15119 | 1.12 | 2 |

TABLE 6
Summary of the datasets in terms of number of samples (left) and
number of attributes for different discretisation methods (right)

| Dataset | #target | #others | r = 0% | r = 0.3% | r = 0.5% | r = 1% | peaks |
|---|---|---|---|---|---|---|---|
| RA | 68 | 138 | 15445 | 1026 | 626 | 319 | 136 |
| IBD | 240 | 240 | 13799 | 1086 | 664 | 338 | 152 |

TABLE 7
Sensitivities, specificities, and error rates obtained by the different decision tree methods for the best value
of the roughness parameter r and using the full class information (post-merging), left on RA, right on IBD

| | RA | | | | IBD | | | |
|---|---|---|---|---|---|---|---|---|
| method | r* | Sensitivity | Specificity | Err. | r* | Sensitivity | Specificity | Err. |
| Single tree | 1.0% | 66.18 (45/68) | 86.23 (119/138) | 20.39 | 1.0% | 81.67 (196/240) | 81.17 (194/239) | 18.58 |
| Bagging | 0.3% | 83.82 (57/68) | 89.13 (123/138) | 12.62 | 1.0% | 85.83 (206/240) | 87.44 (209/239) | 13.36 |
| RF | 1.0% | 89.71 (61/68) | 85.51 (118/138) | 13.11 | 1.0% | 85.42 (205/240) | 92.05 (220/239) | 11.27 |
| ET | 1.0% | 92.65 (63/68) | 86.96 (120/138) | 11.17 | 1.0% | 88.33 (212/240) | 91.63 (219/239) | 10.02 |
| Boosting | 1.0% | 83.82 (57/68) | 94.93 (131/138) | 8.74 | 1.0% | 87.08 (209/240) | 92.05 (220/239) | 10.44 |

TABLE 8
Sensitivities, specificities, and error rates obtained by the different decision tree
methods with the peak alignment and detection algorithm, left on RA, right on IBD

| | RA | | | IBD | | |
|---|---|---|---|---|---|---|
| method | Sensitivity | Specificity | Err. | Sensitivity | Specificity | Err. |
| Single tree | 80.88 (55/68) | 81.88 (113/138) | 18.45 | 72.50 (174/240) | 74.17 (178/240) | 26.67 |
| Bagging | 75.00 (51/68) | 87.68 (121/138) | 16.50 | 84.58 (203/240) | 82.92 (199/240) | 16.25 |
| RF | 83.82 (57/68) | 88.41 (122/138) | 13.11 | 86.25 (207/240) | 87.92 (211/240) | 12.92 |
| ET | 89.71 (61/68) | 86.23 (119/138) | 12.62 | 84.17 (202/240) | 87.50 (210/240) | 14.17 |
| Boosting | 80.88 (55/68) | 92.75 (128/138) | 11.17 | 87.50 (210/240) | 89.58 (215/240) | 11.46 |

TABLE 9
Sensitivities, specificities, and error rates obtained by the
boosting method for different values of the roughness parameter
r, left on RA with boosting, right on IBD with extra-trees

| | RA | | | IBD | | |
|---|---|---|---|---|---|---|
| r | Sensitivity | Specificity | Err. | Sensitivity | Specificity | Err. |
| 0.0% | 88.23 (60/68) | 88.40 (122/138) | 11.65 | 85.00 (204/240) | 87.45 (209/239) | 13.78 |
| 0.3% | 85.29 (58/68) | 90.58 (125/138) | 11.17 | 85.42 (205/240) | 91.21 (218/239) | 11.69 |
| 0.5% | 85.29 (58/68) | 90.58 (125/138) | 11.17 | 85.83 (206/240) | 91.21 (218/239) | 11.48 |
| 1.0% | 83.82 (57/68) | 94.93 (131/138) | 8.74 | 88.33 (212/240) | 91.63 (219/239) | 10.02 |

TABLE 10
Sensitivities, specificities, and error rates obtained by the different decision tree methods for the best value
of the roughness parameter r using only two classes information (pre-merging), left on RA, right on IBD

| | RA | | | | IBD | | | |
|---|---|---|---|---|---|---|---|---|
| method | r* | Sensitivity | Specificity | Err. | r* | Sensitivity | Specificity | Err. |
| Single tree | 0.5% | 73.53 (50/68) | 87.68 (121/138) | 16.99 | 1.0% | 80.42 (193/240) | 83.68 (200/239) | 17.95 |
| Bagging | 0.5% | 64.71 (44/68) | 92.75 (128/138) | 16.50 | 1.0% | 82.50 (198/240) | 83.26 (199/239) | 17.12 |
| RF | 1.0% | 63.24 (43/68) | 94.20 (130/138) | 16.02 | 1.0% | 87.08 (209/240) | 87.87 (210/239) | 12.53 |
| ET | 1.0% | 67.65 (46/68) | 94.20 (130/138) | 14.56 | 1.0% | 86.67 (208/240) | 88.70 (212/239) | 12.32 |
| Boosting | 0.5% | 70.59 (48/68) | 92.75 (128/138) | 14.56 | 1.0% | 89.17 (214/240) | 88.28 (211/239) | 11.27 |

TABLE 11
The ten most discriminant attributes obtained with single decision trees and
boosting with r = 1% and peak detection, top on RA, bottom on IBD

| DT, r = 1% | | | DT, peaks | | | Boosting, r = 1% | | | Boosting, peaks | | |
|---|---|---|---|---|---|---|---|---|---|---|---|
| m/z | % info | Rank | m/z | % info | Rank | m/z | % info | Rank | m/z | % info | Rank |

RA dataset

| | | | | | | | | | | | |
|---|---|---|---|---|---|---|---|---|---|---|---|
| 1054-1064 | 22.96 | 3 | 2924 | 22.78 | 1 | 1054-1064 | 5.65 | 3 | 2924 | 11.38 | 1 |
| 4275-4318 | 15.22 | 168 | 2778 | 9.36 | 21 | 2913-2942 | 3.99 | 1 | 4538 | 7.37 | 44 |
| 5336-5390 | 13.08 | 8 | 9371 | 9.08 | 113 | 4587-4633 | 3.96 | 52 | 10441 | 5.22 | 31 |
| 15324-15478 | 8.72 | 4 | 10441 | 8.01 | 31 | 6144-6206 | 3.78 | 44 | 4825 | 4.42 | 92 |
| 1922-1941 | 8.64 | 141 | 15485 | 7.98 | 67 | 4318-4362 | 3.47 | 2 | 2778 | 4.2 | 21 |
| 2942-2972 | 5.12 | 36 | 9509 | 6.51 | 88 | 4825-4873 | 3.36 | 113 | 5686 | 3.11 | 5 |
| 2330-2354 | 4.98 | 298 | 8145 | 6.36 | 8 | 7588-7665 | 3.34 | 10 | 6669 | 2.29 | 43 |
| 1737-1754 | 4.81 | 299 | 4538 | 6.16 | 44 | 15324-15478 | 2.05 | 4 | 5914 | 2.22 | 54 |
| 3865-3903 | 4.35 | 23 | 14667 | 5.58 | 130 | 4275-4318 | 2 | 168 | 1034 | 1.95 | 24 |
| 2403-2427 | 3.64 | 269 | 3748 | 4.65 | 58 | 5901-5960 | 1.96 | 18 | 4134 | 1.94 | 42 |

IBD dataset

| | | | | | | | | | | | |
|---|---|---|---|---|---|---|---|---|---|---|---|
| 5177-5230 | 32.23 | 1 | 4213 | 27.84 | 1 | 5177-5230 | 11.93 | 1 | 4213 | 13.59 | 1 |
| 9951-10052 | 9.14 | 217 | 13886 | 7.18 | 124 | 5612-5668 | 6.49 | 4 | 3068 | 6.42 | 2 |
| 4189-4232 | 8.86 | 8 | 3218 | 6.79 | 59 | 4189-4232 | 5.5 | 8 | 4238 | 5.84 | 8 |
| 5612-5668 | 7.17 | 4 | 4289 | 6.7 | 66 | 3063-3095 | 3.38 | 2 | 4289 | 4.8 | 66 |
| 13722-13860 | 5.16 | 188 | 5255 | 6.24 | 34 | 4275-4318 | 3.29 | 162 | 24097 | 3.76 | 3 |
| 6332-6396 | 5.14 | 9 | 3320 | 5.71 | 151 | 24048-24290 | 3.2 | 3 | 3163 | 2.93 | 86 |
| 4275-4318 | 4.72 | 162 | 5073 | 4.7 | 115 | 3983-4023 | 2.44 | 17 | 23197 | 2.85 | 10 |
| 2022-2043 | 3.53 | 265 | 7773 | 4.34 | 4 | 23807-24048 | 2.19 | 5 | 5753 | 2.55 | 7 |
| 16111-16274 | 3.39 | 72 | 24332 | 4.2 | 15 | 4728-4776 | 1.84 | 13 | 1945 | 1.83 | 27 |
| 11571-11687 | 3.09 | 336 | 3965 | 4.13 | 137 | 8734-8822 | 1.64 | 67 | 1741 | 1.65 | 11 |

TABLE 12
Sensitivities, specificities, and error rates with the best ensemble method using the N first attributes
ranked by boosting for increasing values of N, left on RA, right on IBD (r = 1%)

| | RA | | | | IBD | | | |
|---|---|---|---|---|---|---|---|---|
| N | Meth. | Sensitivity | Specificity | Err. | Meth. | Sensitivity | Specificity | Err. |
| 1 | ET | 58.82 (40/68) | 74.64 (103/138) | 30.58 | ET | 77.08 (185/240) | 84.10 (201/239) | 19.42 |
| 2 | RF | 63.24 (43/68) | 84.06 (116/138) | 22.82 | ET | 82.08 (197/240) | 81.59 (195/239) | 18.16 |
| 3 | BA | 80.88 (55/68) | 86.96 (120/138) | 15.05 | ET | 80.00 (192/240) | 89.12 (213/239) | 15.45 |
| 4 | DT | 85.29 (58/68) | 85.51 (118/138) | 14.56 | ET | 83.75 (201/240) | 84.94 (203/239) | 15.66 |
| 5 | ET | 85.29 (58/68) | 87.68 (121/138) | 13.11 | ET | 82.92 (199/240) | 83.68 (200/239) | 16.70 |
| 10 | BO | 88.24 (60/68) | 92.75 (128/138) | 8.74 | RF | 82.92 (199/240) | 87.87 (210/239) | 14.61 |
| 15 | BO | 86.76 (59/68) | 94.93 (131/138) | 7.77 | RF | 84.58 (203/240) | 90.38 (216/239) | 12.53 |
| 20 | BO | 91.18 (62/68) | 94.93 (131/138) | 6.31 | RF | 84.58 (203/240) | 92.05 (220/239) | 11.69 |
| 25 | BO | 89.71 (61/68) | 94.93 (131/138) | 6.80 | RF | 89.58 (215/240) | 92.05 (220/239) | 9.19 |
| 50 | ET | 92.65 (63/68) | 92.75 (128/138) | 7.28 | ET | 90.00 (216/240) | 94.98 (227/239) | 7.52 |
| 75 | BO | 83.82 (57/68) | 95.65 (132/138) | 8.25 | ET | 90.83 (218/240) | 95.82 (229/239) | 6.68 |
| 100 | BO | 86.76 (59/68) | 95.65 (132/138) | 7.28 | RF | 89.58 (215/240) | 95.40 (228/239) | 7.52 |
| ALL | BO | 83.82 (57/68) | 94.93 (131/138) | 8.74 | ET | 88.33 (212/240) | 91.63 (219/239) | 10.02 |

TABLE 13
Sensitivities, specificities, and error rates when combining
the classifications of the four replicas associated to a patient,
on the IBD problem with boosting and r = 1%, top without
attribute selection, bottom with attribute selection

| M | Sensitivity | Specificity | Err. |
|---|---|---|---|
| 1 | 93.33 (56/60) | 83.33 (50/60) | 11.66 |
| 2 | 91.66 (55/60) | 93.33 (56/60) | 7.50 |
| 3 | 86.66 (52/60) | 93.33 (56/60) | 10.00 |
| 4 | 76.66 (46/60) | 98.33 (59/60) | 12.50 |
| 1 | 95.00 (57/60) | 86.67 (52/60) | 9.17 |
| 2 | 93.33 (56/60) | 98.33 (59/60) | 4.17 |
| 3 | 91.67 (55/60) | 98.33 (59/60) | 5.00 |
| 4 | 80.00 (48/60) | 98.33 (59/60) | 10.83 |

TABLE 14
Sensitivities, specificities and accuracy obtained by
decision-tree boosting analysis, on data acquired a) on the
entire group and b) on the actives patients only.
On CM10 and Q10 chip, the specificity and sensitivity
scores are calculated by Leave-One-Out, with
r = 0.5% as pre-processing step factor.

| | | |
|---|---|---|
| sensitivity | specificity | accuracy |

a
All patients

| | | | | | |
|---|---|---|---|---|---|
| Q10 | | | | | |
| IBD vs Controls | 90% (54/60) | 92% | (55/60) | 91% | (19/120) |
| CD vs UC | 80% (24/30) | 87% | (26/30) | 83% | (50/60) |
| CD vs all other | 87% (26/30) | 99% | (89/90) | 96% | (115/120) |
| UC vs all other | 67% (20/30) | 94% | (85/90) | 87% | (105/120) |
| CM10 | | | | | |
| IBD vs Controls | 90% (54/60) | 98% | (59/60) | 94% | (113/120) |
| CD vs UC | 97% (29/30) | 83% | (25/30) | 90% | (54/60) |
| CD vs all other | 93% (28/30) | 96% | (86/90) | 95% | (114/120) |
| UC vs all other | 67% (20/30) | 100% | (90/90) | 92% | (110/120) |

b
Actives Patients

| | | | | | |
|---|---|---|---|---|---|
| Q10 | | | | | |
| IBD vs Controls | 97% (29/30) | 100% | (30/30) | 98% | (59/60) |
| CD vs UC | 60% (9/15) | 93% | (14/15) | 77% | (23/30) |
| CD vs all other | 53% (8/15) | 98% | (44/45) | 87% | (52/60) |
| UC vs all other | 87% (13/15) | 91% | (41/45) | 90% | (54/60) |
| CM10 | | | | | |
| IBD vs Controls | 97% (29/30) | 100% | (30/30) | 98% | (59/60) |
| CD vs UC | 80% (12/15) | 93% | (14/15) | 87% | (26/30) |
| CD vs all other | 73% (11/15) | 98% | (44/45) | 92% | (55/60) |
| UC vs all other | 80% (12/15) | 98% | (44/45) | 93% | (56/60) |

TABLE 15
The most discriminent biomarkers, on CM10 ranked according to imp(%) and with associated. “p-value”

| I.B.D.-versus-ALL | | | I.B.D.-versus-I.C. | | | C.D.-versus-ALL | | | C.D.-versus-ALL | | |
|---|---|---|---|---|---|---|---|---|---|---|---|
| All patients | | | Active patients | | | All patients | | | Active patients | | |
| m/z | imp % | p-Value | m/z | imp % | p-Value | m/z | imp % | p-Value | m/z | imp % | p-Value |
| 5194-5221 | 11.2 | 0 | 5990-6021 | 65.11 | 0 | 1733-1742 | 6.1 | 0 | 2662-2676 | 11.4 | 3.2 10⁻⁸ |
| 4212-4233 | 6.4 | 2 10⁻⁸ | 3838-3858 | 6.54 | 0 | 4713-4737 | 4.6 | 0 | 9005-9050 | 8.2 | 6.4 0 − 7 |
| 5636-5665 | 5.7 | 0 | 4148-4169 | 6.31 | 0 | 1940-1950 | 4.4 | 4.3 10⁻⁸ | 3838-3858 | 7.0 | 4.3 10⁻⁸ |
| 4276-4298 | 2.0 | 0.1 | 3093-3109 | 3.51 | 0 | 3076-3093 | 3.0 | 1.8 10⁻⁸ | 2676-2690 | 5.9 | 1.6 10⁻⁸ |
| 3060-3076 | 1.8 | 10⁻¹⁰ | 4000-4021 | 2.67 | 10⁻¹⁰ | 5636-5665 | 2.0 | 3.56 10⁻⁸ | 9050-9096 | 3.2 | 4.0 10⁻⁷ |
| 23929-24051 | 1.5 | 4 10⁻¹⁰ | 4126-4148 | 2.38 | 0 | 1892-1902 | 1.9 | 7.9 10⁻⁹ | 14290-14362 | 2.5 | 2.3 10⁻⁶ |
| 6532-6566 | 1.4 | 2.0 10⁻⁸ | 7576-7614 | 2.36 | 8.4 10⁻⁹ | 5194-5221 | 1.9 | 1.7 10⁻⁷ | 14218-14290 | 3.6 | 1.6 10⁻⁶ |
| 5221-5247 | 1.4 | 3.9 10⁻⁹ | 7614-7652 | 2.11 | 2 10⁻⁸ | 5990-6021 | 1.7 | 1.6 10⁻⁸ | 9096-9143 | 1.6 | 9.6 10⁻⁷ |
| 24051-24173 | 1.4 | 10⁻¹⁰ | 4021-4042 | 2.02 | 0 | 6021-6052 | 1.7 | 1.9 10⁻⁸ | 3685-3704 | 1.5 | 3.2 10⁻⁶ |
| 4298-4319 | 1.2 | 19 10⁻² | 2223-2234 | 1.13 | 1.8 10⁻² | 5753-5782 | 1.4 | 7 10⁻¹⁰ | 8781-8825 | 1.5 | 6.2 10⁻⁶ |

| U.C.-versus-ALL | | | U.C.-versus-ALL | | | U.C.-versus-C.D. | | | U.C.-versus-C.D. | | |
|---|---|---|---|---|---|---|---|---|---|---|---|
| All patients | | | Active patients | | | All patients | | | Active patients | | |
| m/z | imp % | p-Value | m/z | imp % | p-Value | m/z | imp % | p-Value | m/z | imp % | p-Value |
| 4042-4063 | 2.6 | 0.1 | 4341-4363 | 7.9 | 5.6 10⁻⁵ | 2648-2662 | 6.4 | 5.7 10⁻⁷ | 2662-2676 | 9.2 | 2.0 10⁻⁵ |
| 4276-4298 | 2.0 | 0.3 | 2662-2676 | 4.7 | 0.1 | 1733-1742 | 4.2 | 5.2 10⁻⁷ | 2676-2690 | 7.4 | 6.2 10⁻⁶ |
| 1982-1993 | 1.8 | 5.6 10⁻⁵ | 4126-4148 | 4.1 | 7.5 10⁻⁵ | 1280-1287 | 3.4 | 5.7 10⁻⁷ | 3685-3704 | 6.9 | 9.7 10⁻⁵ |
| 13177-13244 | 1.8 | 1.3 10⁻⁴ | 5436-5464 | 3.6 | 2.0 10⁻⁶ | 8781-8825 | 3.3 | 2.7 10⁻² | 1892-1902 | 5.0 | 6.7 10⁻⁴ |
| 4298-4319 | 1.5 | 0.9 | 6242-6274 | 3 | 6.0 10⁻⁴ | 3125-3142 | 3.4 | 1.3 10⁻² | 8825-8870 | 3.3 | 7.8 10⁻⁴ |
| 4212-4233 | 1.3 | 1.5 10⁻² | 17671-17761 | 2.7 | 5.1 10⁻⁶ | 6021-6052 | 2.9 | 2.6 10⁻³ | 9970-10021 | 3.1 | 1.9 10⁻³ |
| 5436-5464 | 11 | 8.0 10⁻² | 4385-4408 | 2.3 | 3.9 10⁻⁴ | 5990-6021 | 2.8 | 2.3 10⁻³ | 8960-9005 | 2.9 | 1.2 10⁻³ |
| 6242-6274 | 1.0 | 0.9 | 17852-17942 | 2.1 | 5.6 10⁻⁶ | 1892-1902 | 2.6 | 1.2 10⁻⁵ | 11788-11848 | 2.4 | 1.3 10⁻² |
| 17852-17942 | 1.0 | 0.1 | 6147-6178 | 1.9 | 1.2 10⁻⁴ | 5959-5990 | 2.5 | 1.7 10⁻³ | 1327-1334 | 1.8 | 3.6 10⁻⁴ |
| 5194-5221 | 1 | 1.6 10⁻³ | 4363-4385 | 1.9 | 1.7 10⁻⁴ | 4689-4713 | 2.1 | 5.0 10⁻⁷ | 8870-8915 | 1.7 | 19 10⁻³ |

TABLE 16
The most discriminent biomarkers, on Q10 ranked according to imp(%) and with associated “p-value”

| I.B.D.-versus-ALL | | | I.B.D.-versus-I.C. | | | C.D.-versus-ALL | | | C.D.-versus- ALL | | |
|---|---|---|---|---|---|---|---|---|---|---|---|
| All patients | | | Active patients | | | All patients | | | Active patients | | |
| m/z | imp % | p-Value | m/z | imp % | p-Value | m/z | imp % | p-Value | m/z | imp % | p-Value |
| 4618-4642 | 12.7 | 0 | 4408-4431 | 82.9 | 0 | 4618-4642 | 6.8 | 5.9 10⁻⁹ | 4618-4642 | 12.5 | 5.6 10⁻⁶ |
| 12464-12527 | 4.6 | 1.2 10⁻⁸ | 15572-15652 | 12 | 0 | 4408-4431 | 5.2 | 2.8 10⁻⁵ | 4408-4431 | 8.85 | 6.010⁻⁴ |
| 1261-1267 | 4.3 | 5 10⁻¹⁰ | 4298-4319 | 2 | 0 | 1585-1593 | 5.1 | 0 | 1391-1398 | 3.81 | 2.9 10⁻⁵ |
| 1733-1742 | 2.8 | 3.3 10⁻⁶ | 15494-15572 | 2 | 0 | 4809-4834 | 3.9 | 1.5 10⁻⁷ | 1280-1287 | 3.51 | 8.2 10⁻⁷ |
| 12400-12464 | 2.7 | 8.9 10⁻⁹ | 1109-1115 | 1.0 | 0.7 | 1383-1391 | 2.7 | 0 | 1383-1391 | 2.98 | 1.9 10⁻⁵ |
| 6210-6242 | 2.2 | 1.5 10⁻⁹ | 1006-1011 | 0.1 | 0.4 | 1733-1742 | 2.5 | 1.4 10⁻⁹ | 4084-4105 | 2.79 | 1.39 10⁻⁴ |
| 12337-12400 | 2.0 | 2.4 10⁻⁸ | | | | 1391-1398 | 2.3 | 3 10⁻¹⁰ | 1705-1714 | 2.42 | 1.110⁻² |
| 1921-1931 | 1.8 | 3 10⁻⁹ | | | | 1280-1287 | 2.2 | 2 10⁻¹⁰ | 6634-6669 | 2.4 | 6.5 10⁻⁶ |
| 1398-1406 | 1.4 | 1.2 10⁻⁷ | | | | 1724-1733 | 2.2 | 1.2 10⁻⁹ | 4298-4319 | 2.4 | 5.2 10⁻⁴ |
| 4454-4477 | 1.4 | 1.2 10⁻⁷ | | | | 4834-4858 | 2.1 | 2.9 10⁻⁹ | 1585-1593 | 2.2 | 4.4 10⁻⁶ |

| U.C.-versus-ALL | | | U.C.-versus-ALL | | | U.C.-versus-C.D. | | | U.C.-versus-C.D. | | |
|---|---|---|---|---|---|---|---|---|---|---|---|
| All patients | | | Active patients | | | All patients | | | Active patients | | |
| m/z | imp % | p-Value | m/z | imp % | p-Value | m/z | imp % | p-Value | m/z | imp % | p-Value |
| 1459-1467 | 3.5 | 6.5 10⁻⁶ | 15417-15494 | 7.5 | 4.0 10⁻⁶ | 6634-6669 | 5.2 | 8.654E-07 | 1280-1287 | 6 | 6.9 10⁻⁵ |
| 12464-12527 | 3.1 | 7.2 10⁻⁵ | 4666-4689 | 3.7 | 9.6 10⁻⁷ | 1585-1593 | 3.96 | 1.993E-07 | 1678-1687 | 4.1 | 7.8 10⁻⁴ |
| 6634-6669 | 2.4 | 1.39 10⁻² | 15033-15109 | 3.4 | 3.6 10⁻⁵ | 12591-12654 | 3.33 | 0.008792977 | 1705-1714 | 3.3 | 9.1 10⁻³ |
| 1452-1459 | 2.3 | 2.5 10⁻⁶ | 18033-18124 | 2.8 | 2.3 10⁻⁵ | 1280-1287 | 2.65 | 3.222E-07 | 6634-6669 | 3.2 | 1.3 10⁻² |
| 13860-13931 | 2.2 | 0.56 | 1561-1569 | 2.7 | 1.4 10⁻⁵ | 4408-4431 | 2.61 | 0.027105162 | 1391-1398 | 3 | 1.6 10⁻³ |
| 12654-12718 | 1.9 | 4.5 10⁻⁵ | 18216-18307 | 2.4 | 4.1 10⁻⁵ | 1678-1687 | 2.31 | 7.421E-07 | 1724-1733 | 2.8 | 1.6 10⁻³ |
| 4618-4642 | 1.7 | 1.7 10⁻² | 15652-15732 | 1.9 | 4.7 10⁻⁶ | 1724-1733 | 2.22 | 9.584E-07 | 4618-4642 | 2.6 | 8.2 10⁻² |
| 6434-6467 | 1.5 | 4.1 10⁻³ | 14880-14956 | 1.8 | 2.7 10⁻⁶ | 4809-4834 | 2.09 | 3.32475E-05 | 1383-1391 | 1.8 | 5.8 10⁻⁴ |
| 1261-1267 | 1.5 | 4.1 10⁻⁵ | 1678-1687 | 1.8 | 2.2 10⁻² | 1459-1467 | 2.05 | 0.0002156 | 10331-10383 | 1.8 | 0.8 |
| 1467-1475 | 1.5 | 6.9 10⁻⁵ | 4501-4524 | 1.8 | 4.0 10⁻⁶ | 12782-12847 | 2.05 | 1.1739E-06 | 10436-10488 | 1.8 | 0.9 |

1. A method for determining a classifier for a biological condition of a specific disease comprising the steps of:
providing a plurality of mass spectra;
determining input attributes from one or more of the plurality of mass spectra to generate a learning set;
determining for the learning set a first classifier using a first ensemble of decision trees method;
determining for the learning set a second classifier using a second ensemble of decision trees method;
determining for the learning set a third classifier using a third ensemble of decision trees method;
determining for the learning set a fourth classifier using a fourth ensemble of decision trees method;
evaluating for each of said first, second, third and fourth classifiers one or more of sensitivity, specificity, and error rate; and
selecting one of the first, second, third and fourth classifiers as a candidate classifier based on at least one or more of sensitivity, specificity, and error rate.

2. The method of claim 1, further comprising a step for determining a set of one or more biomarkers for a biological condition of a specific disease comprising the steps of:
ranking the attributes according to a classifier; and
determining one or more biomarkers based on at least said ranking.

3. The method of claim 2, wherein ranking the attributes comprises computing for each attribute a total reduction of the classification entropy due to splits at the tree nodes based on this attribute, as defined by the following expression for a node:
I(node)=#SH_{C}(S)−#SₜH_{c}(Sₜ)−#S_{f}H_{C}(S_{f}),
where S denotes the subsample of cases that reach this node, #S denotes the size of this node, Sₜ denotes the subsample of them for which the test is true, S_{f} denotes the subsample of them for which the test is false, and Hc(−) computes the Shannon entropy of the class frequencies in a subset of samples.

4. The method of claim 2, wherein the step of determining a set of one or more biomarkers based on the ranking of the attributes comprises:
using only the top ranked attributes while progressively increasing their number to define a sequence of learning sets;
determining for each learning set a first classifier using a first ensemble of decision trees method;
determining for each learning set a second classifier using a second ensemble of decision trees method;
determining for each learning set a third classifier using a third ensemble of decision trees method;
determining for each learning set a fourth classifier using a fourth ensemble of decision trees method;
evaluating for each of said first, second, third, and fourth classifiers one or more of sensitivity, specificity, and error rate;
selecting for each learning set one of the first, second, third, and fourth classifiers based on at least one or more of sensitivity, specificity, and error rate;
selecting a candidate set of attributes from the sequence of selected classifiers based on at least one or more of sensitivity, specificity, and error rate; and
determining a set of one or more biomarkers from the candidate set of attributes.

5. The method of claim 2, further comprising the step of:
determining a classifier for this set of biomarkers.

6. The method of claim 5, wherein the step of determining a classifier for the set of biomarkers comprises:
selecting as input attributes the set of biomarkers to define the learning set;
determining for each learning set a first classifier using a first ensemble of decision trees method;
determining for each learning set a second classifier using a second ensemble of decision trees method;
determining for each learning set a third classifier using a third ensemble of decision trees method;
determining for each learning set a fourth classifier using a fourth ensemble of decision trees method;
evaluating for each of said first, second, third and fourth classifiers one or more of sensitivity, specificity, and error rate;
selecting one of the first, second, third and fourth classifiers as a candidate classifier based on at least one or more of sensitivity, specificity, and error rate.

7. The method of claim 1, wherein determining a classifier for a learning set comprises one or more of class merging or aggregation of measurements.

8. The method of claim 1, wherein the first ensemble of trees comprises a bagging ensemble of decision trees method.

9. The method of claim 1, wherein the second ensemble of trees comprises a random forest ensemble of decision trees method.

10. The method of claim 1, wherein the third ensemble of trees comprises an extra-trees ensemble of decision trees method.

11. The method of claim 1, wherein the fourth ensemble of trees comprises a boosting ensemble of decision trees method.

12. The method of claim 1, wherein the step of evaluating a set of classifiers comprises using a leave-one-out cross-validation method to determine one or more of sensitivity, specificity and error rate.

13. The method of claim 1, wherein the step of selecting a classifier comprises selecting a set of classifiers based on the global error rate.

14. The method of claim 2, wherein the set of biomarkers comprises one or more peptides, polypeptides, or combinations thereof.

15. The method of claim 1, wherein the specific disease is an inflammatory disease preferably rheumatoid arthritis, psoriatic arthritis, Crohn's disease, ulcerative colitis, asthma or chronical bronchopneupathy.

16. The method of claim 1, wherein the step of determining input attributes comprises using a discretization method having a roughness parameter r preferably with a value in the range between 0.0% and 1.0%

17. The method of claim 1, wherein the mass spectra comprise SELDI-TOF mass spectra.

18. An article of manufacture comprising a computer-readable medium with computer-readable instructions embodied thereon for performing the method of claim 1.

19. A computer-based system for determining a biomarker for a biological condition of a specific disease, comprising:
a computer comprising:
a processor capable of accessing a database of mass spectrometric signals from individual members of a test population, a first subpopulation of said members being identified as having a specified biological condition and a second subpopulation of said members being identified as not having the specified biological condition; and
a computer-readable medium having embedded thereon computer-readable instructions that include steps for performing the method of claim 1.

20. A method of assessing whether a subject is in a biological condition of a specific disease, the method comprising:
a) detecting in a subject sample, the presence of a set of biomarkers determined by the method according to claim 2, the set of biomarkers having one or more polypeptides with a specific molecular mass;
b) comparing the presence of the biomarkers in the subject sample to corresponding biomarkers in a group of control samples, and
c) verifying a significant difference between the amplitude of the biomarkers in the subject sample and in the group of control samples

21. The method of claim 20, wherein comparing the presence of the biomarkers in the subject sample to corresponding biomarkers in a group of control samples is done using a classifier determined by a the method of claim 1.

22. A biomarker or a biomarkers combination identified by the method of claim 2.

23. An assay which employs a biomarker or a biomarkers combination identified by the method of claim 1.

24. A kit for assessing whether a subject is in a biological condition of a specific disease comprising a reagent for assessing the presence in a subject sample of a set of biomarkers determined by the method of claim 2.

25. A method of diagnosis of a specific disease employing a biomarker or a biomarker combination identified by the method of claim 2.
